(19) United States
(12) Patent Application Publication
(10) Pub. No.: US 2006/0136240 A1
(43) Pub. Date: Jun. 22, 2006

(54) System and method for assessing and improving the extent of diversity in business organizations

(76) Inventors: Joseph R. Cleveland, Orlando, FL (US); Shantella Carr, Germantown, MD (US); Bradley B. Myers, Orlando, FL (US); Marilyn S. Blackburn, Orlando, FL (US); Lynn M. Katz, Winter Park, FL (US); Kelly M. Morishita, Washington, DC (US)

Correspondence Address: WELSH & KATZ, LTD, 120 S RIVERSIDE PLAZA, 22ND FLOOR, CHICAGO, IL, 60606, US

(21) Appl. No.: 11/017,596

(22) Filed: Dec. 20, 2004

(51) Int. Cl. G06Q 99/00

(52) U.S. Cl. 705/1

(57) ABSTRACT

A system and method of evaluating and enhancing diversity of an entity utilizes employee responses, entity self-assessment responses and relevant objective data to determine a rating indicative of a current level of diversity. The responses and data can be analyzed to determine steps to be taken to enhance the current level of diversity. Subsequent to the steps having been taken, another rating can be determined indicative of a most recent level of diversity. The most recent level of diversity can be compared with the prior level to evaluate progress from one level to another.

### FIELD OF THE INVENTION

The invention pertains to business methods. More particularly, the invention pertains to systems and methods for developing a more diverse work force and environment within a business or governmental entity, or other organization.

### BACKGROUND OF THE INVENTION

Business entities have recognized that the ability to attract and retain talent can mean the difference between success and failure in a competitive economy. For a non-profit or governmental entity, it can mean the difference between program success and failure.

In a multi-ethnic, multi-cultural society, a potential work force can be expected to be filled with talented individuals from many different types of backgrounds, religions, ethnic groups, disabilities, sexual orientations and/or family status. The ability to attract and retain a very diverse group of employees becomes a very positive and important business or governmental asset. In fact, mission success may be dependent on the organization's ability to develop a more diverse work force, or universe of suppliers or vendors.

In addition to a work environment that enables an entity to benefit from differing employee experiences and skills in life, and from different outlooks in addressing and successfully accomplishing outstanding tasks, a climate where a diverse that is promoted and encouraged also contributes to employee satisfaction and long term retention of such employees. This is particularly important in circumstances where there are long product life cycles. Such cycles can include not only relatively long term development phases, but also long term product usage requiring customer support and an understanding of program and product history which may be needed for business continuity. Market success may be dependent on understanding a culturally and ethnically diverse actual or potential client base, or universe of vendors and suppliers.

Statutory and regulatory provisions are established and enforced for purposes of promoting equal employment opportunities, promoting affirmative action and the like. Nevertheless it would be desirable to be able to move beyond legally mandated standards to provide an inclusive environment where talented individuals, men, women, from all walks of life, with various religious or cultural backgrounds, and with or without disabilities, have an opportunity to contribute to the success of their respective entities at all levels.

An inclusive, more diverse environment should enable a business entity to become a more effective competitor, exhibit increased performance, creativity and innovation, and improved productivity. Such an environment would not only increase employee fulfillment and success but would also provide for greater program or mission success. Similar comments apply to improving the environment and diversity levels of other organizations such as governmental or non-profit entities. Such entities would also benefit from enhanced degrees of diversity.

Preferably, the above objectives could be facilitated and achieved by providing a common language or definition of diversity, along with a standardized behavior based framework for evaluating diversity within a portion of an entity or across the entire entity. Further, it would be desirable to provide a uniform process which can be used to measure and assess diversity progress. It would also be desirable if the process was iterative in nature with results being usable to make further adjustments or improvements in diversity levels throughout portions or all of the entity so as to enable the business entity and all its employees to participate in and benefit from the diverse work environment.

### SUMMARY OF THE INVENTION

A method of assessing diversity of human resources of a business includes establishing a model that comprises information representative of progressive levels of diversity and selected business characteristics. The method further includes assessing, in relation to the model, data representative of diversity of the business, and producing a diversity rating for the business. Further aspects of the invention provide for improving and re-assessing diversity to determine progress.

### BRIEF DESCRIPTION OF THE DRAWINGS

FIG. 1A is a diagram of an exemplary multi-level model including multiple key business characteristics in accordance with the invention;

FIGS. 1B and 1C are charts showing further details of the model of FIG. 1A;

FIG. 2 is a flow diagram of an exemplary method of assessing and improving diversity in accordance with the model of FIGS. 1A-1C;

FIG. 3 is a diagram indicative of types of data collected in carrying out the method of FIG. 2;

FIG. 4 illustrates a data processing operation to determine a current overall level of diversity;

FIG. 5 illustrates an exemplary employee survey;

FIGS. 6A, 6B illustrate details of processing responses to an exemplary survey question;

FIG. 7 illustrates details of processing responses to a plurality of exemplary survey questions;

FIG. 8 illustrates exemplary business unit self-assessment questions;

FIG. 9 illustrates business unit self-assessment related processing associated with selected operational business characteristics;

FIG. 10 illustrates details of objective data processing;

FIG. 11 illustrates various exemplary business characteristic weightings;

FIG. 12 illustrates additional processing details in determining a current over-all diversity level;

FIGS. 13A and 13B together illustrate processing operations to determine business unit diversity, and to permit performance of gap analysis for developing an action plan to improve diversity;

FIG. 14 is a block diagram showing a method of assessment and re-assessment of diversity for determining extent of progress in diversity;

FIG. 15 is a block diagram of a system in accordance with the invention; and

FIG. 16 illustrates an exemplary display for presenting various diversity related values.

### DETAILED DESCRIPTION OF THE INVENTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

Methods and systems which embody the invention provide a standardized, behaviorally based framework for viewing employee diversity level(s) in a business, governmental entity or non-governmental non-profit organization. In this regard, a common language or diversity definition levels, cohesive approaches, and uniform processes can be used to measure and assess past and present levels of diversity. Collected data can be analyzed and plans developed to improve diversity level(s) and/or to address gaps in business organization processes or activities.

The methods and systems can be based on a multi-level, multi-dimensional (multiple key business characteristics) diversity model. Increasing levels of diversity are expressed in the model in terms of various aspects of selected business characteristics. These characteristics can include, without limitation, commitment of the organization's leadership to improving diversity within the organization, organizational culture and climate, work force strategy and development, and customer relationship and management.

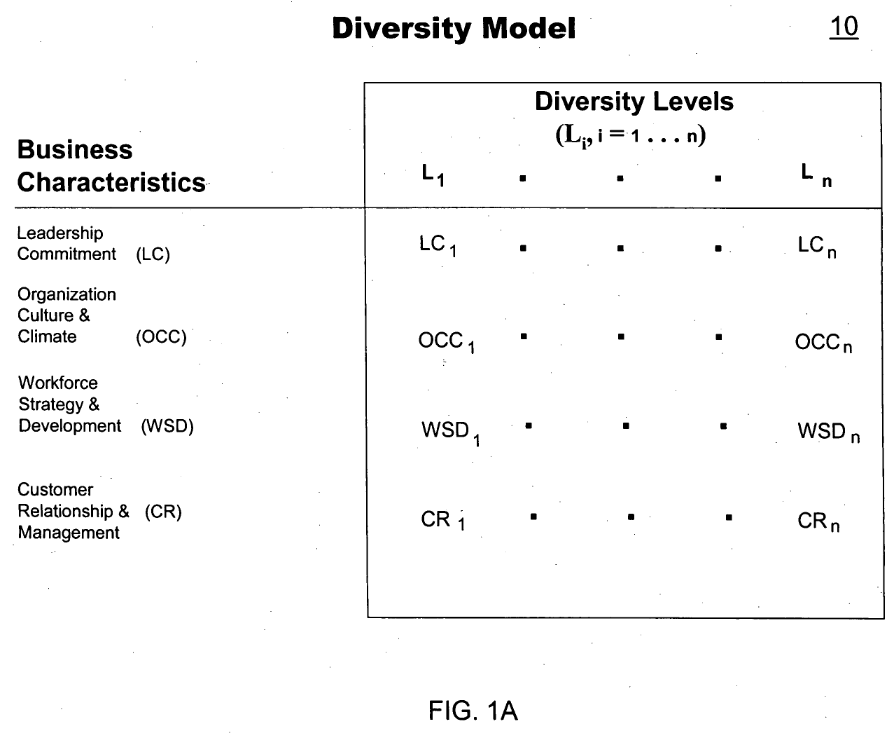

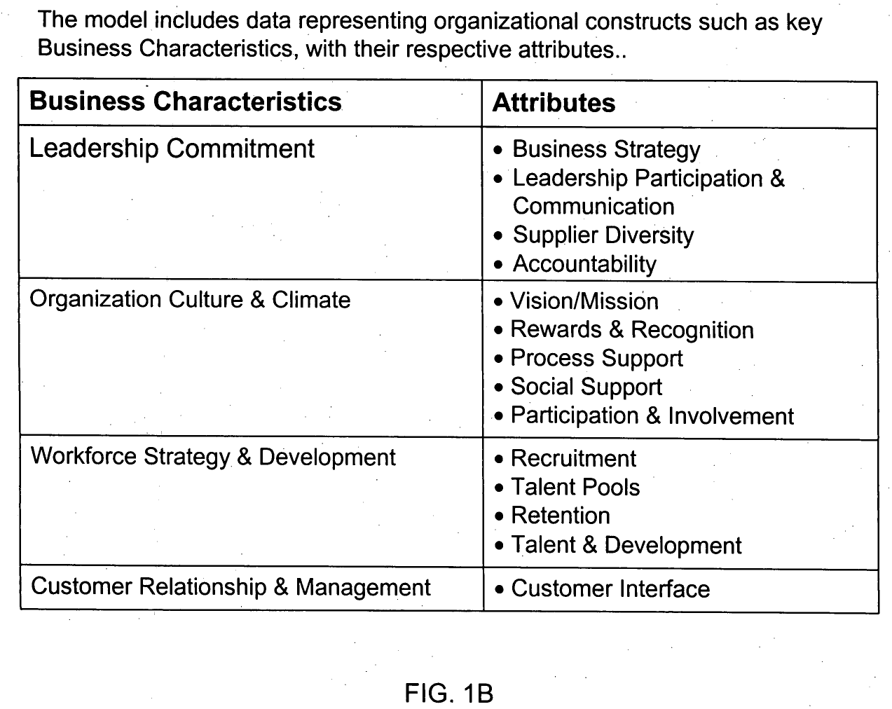

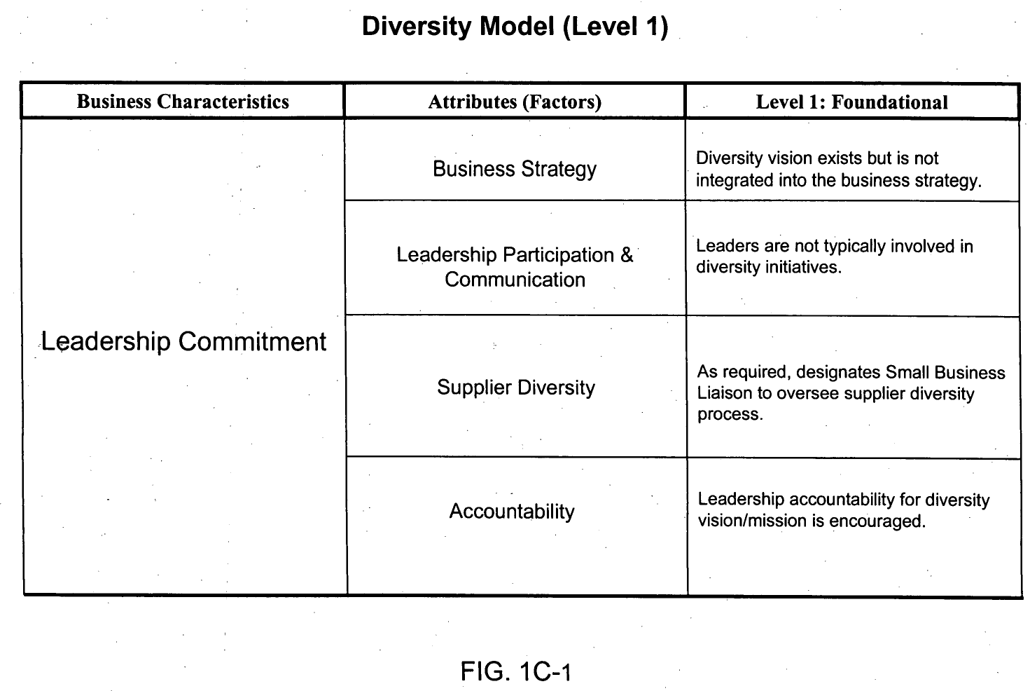

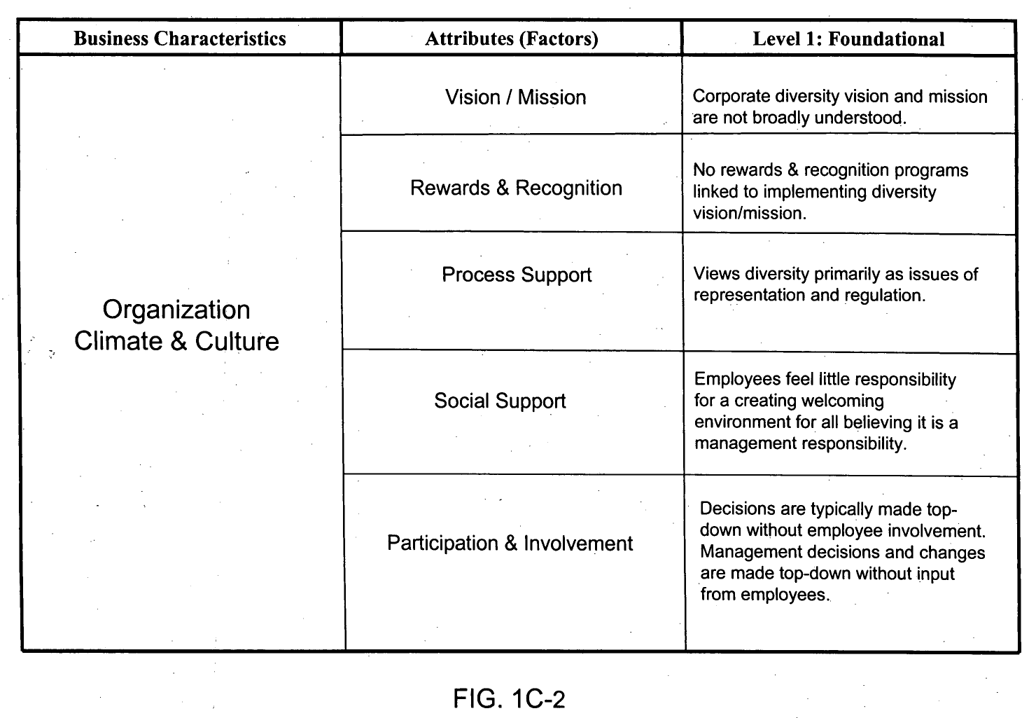

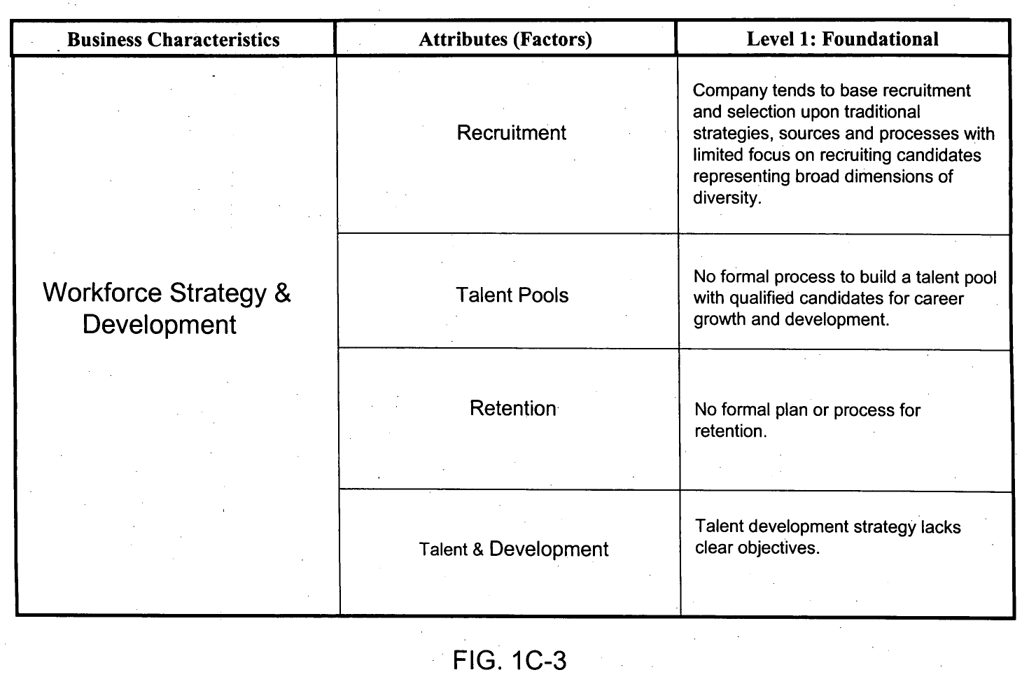

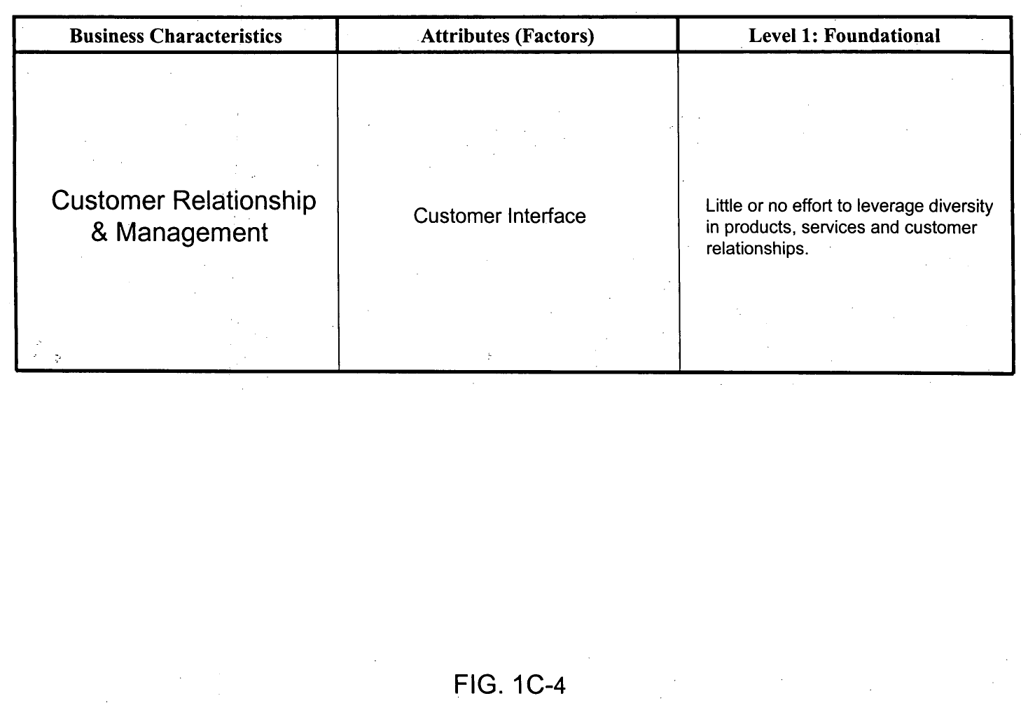

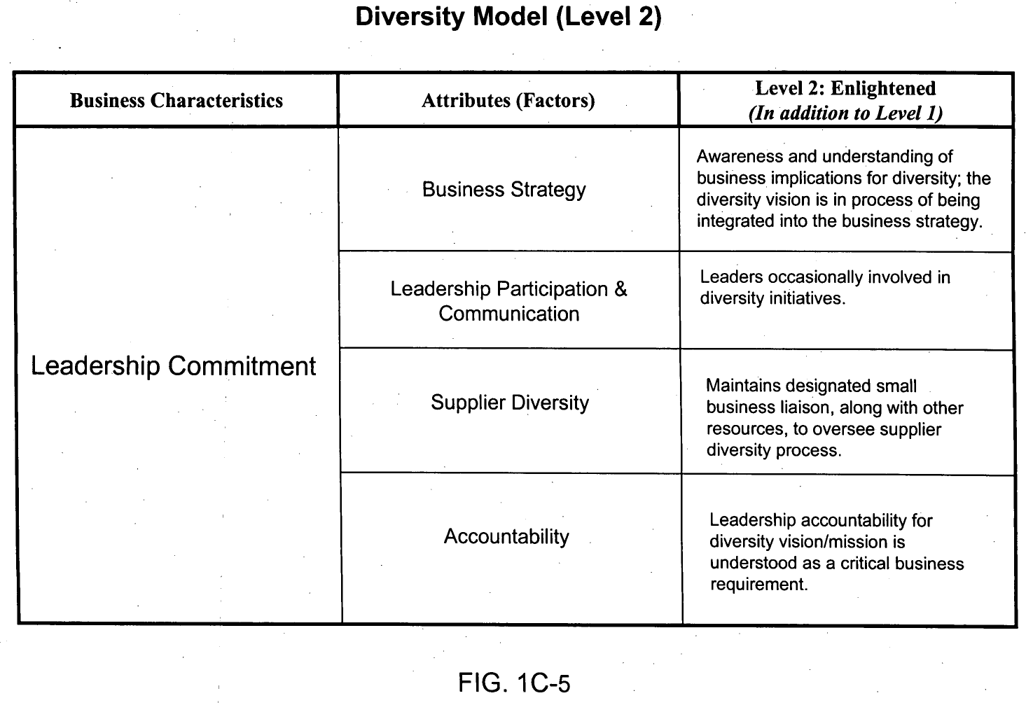

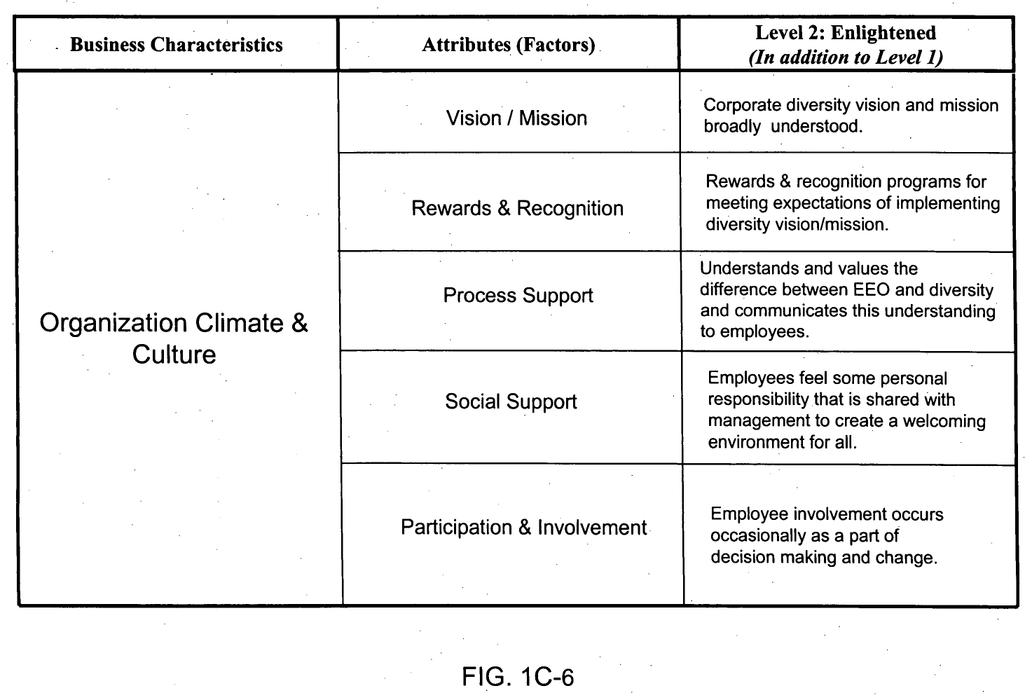

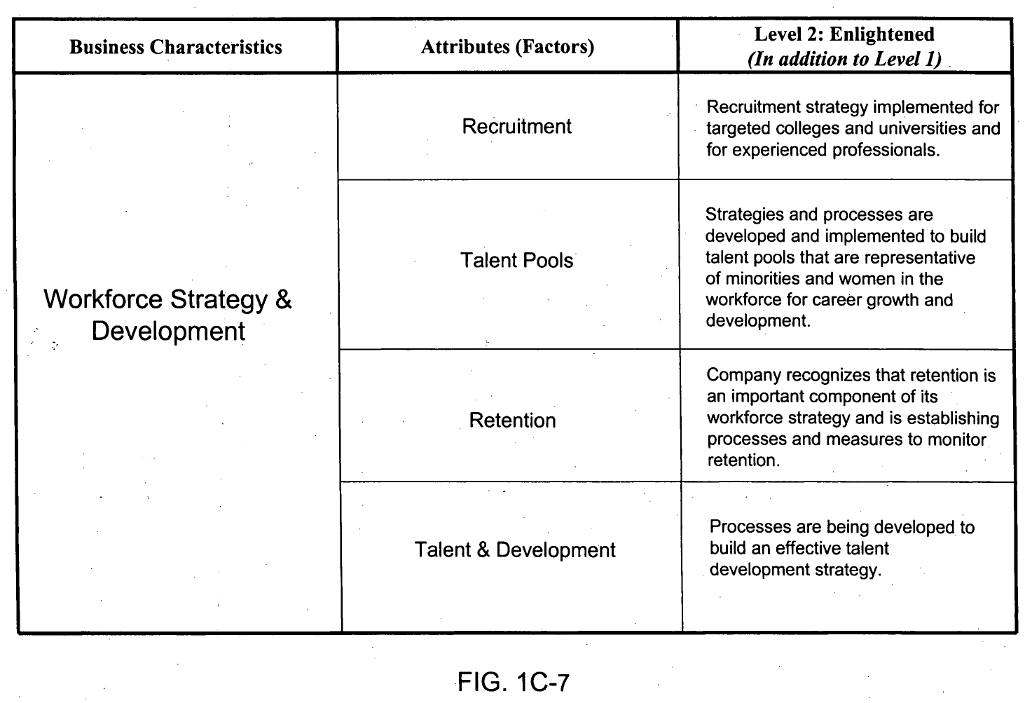

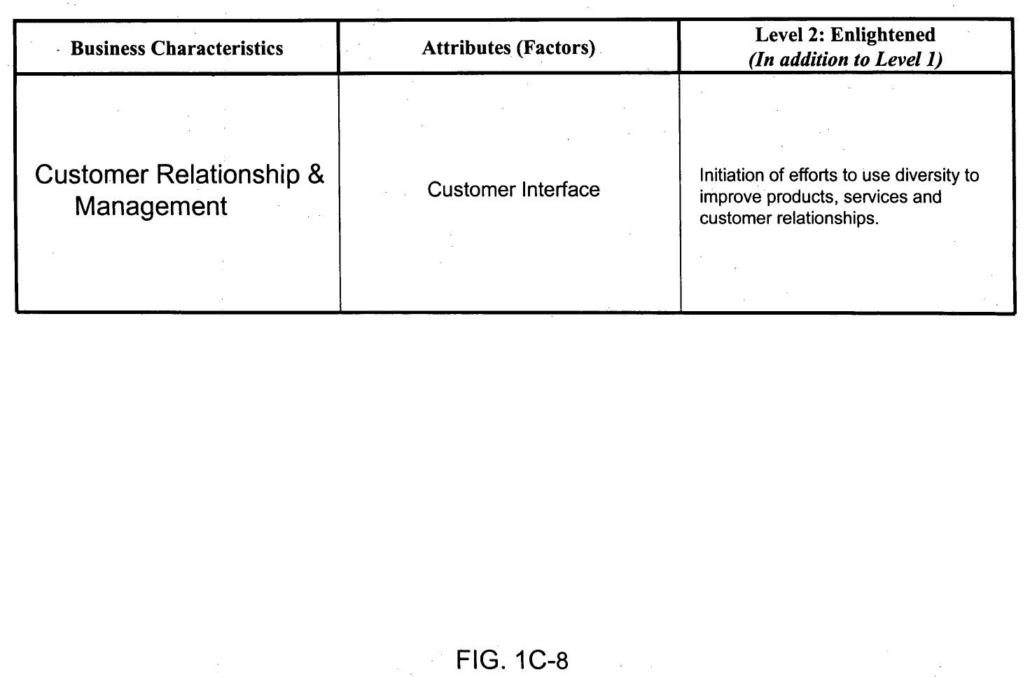

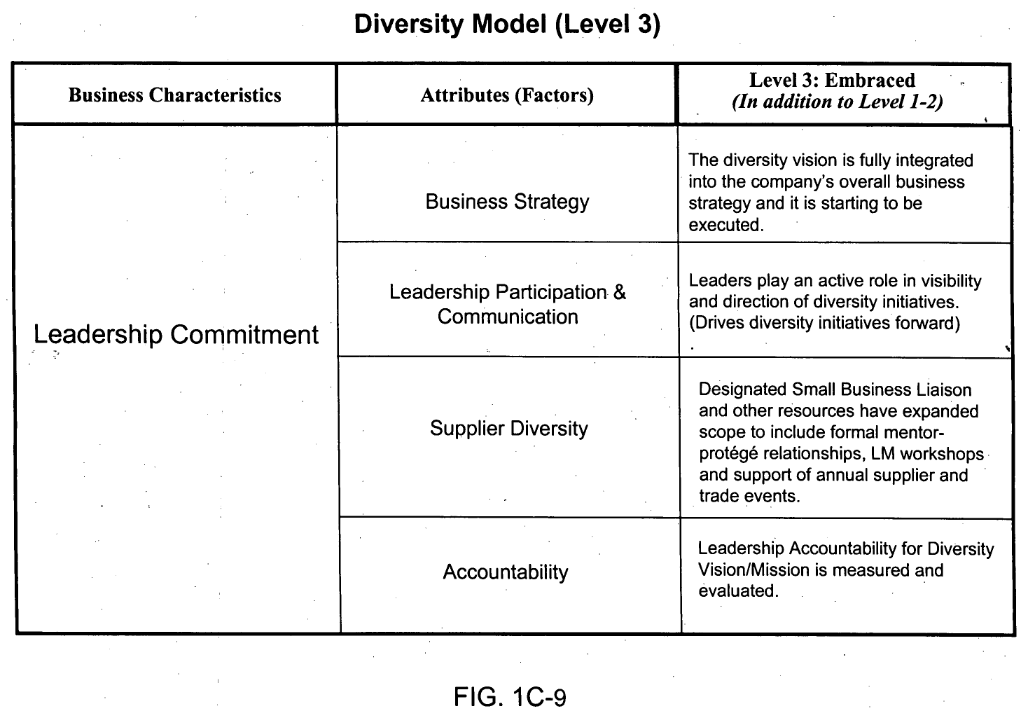

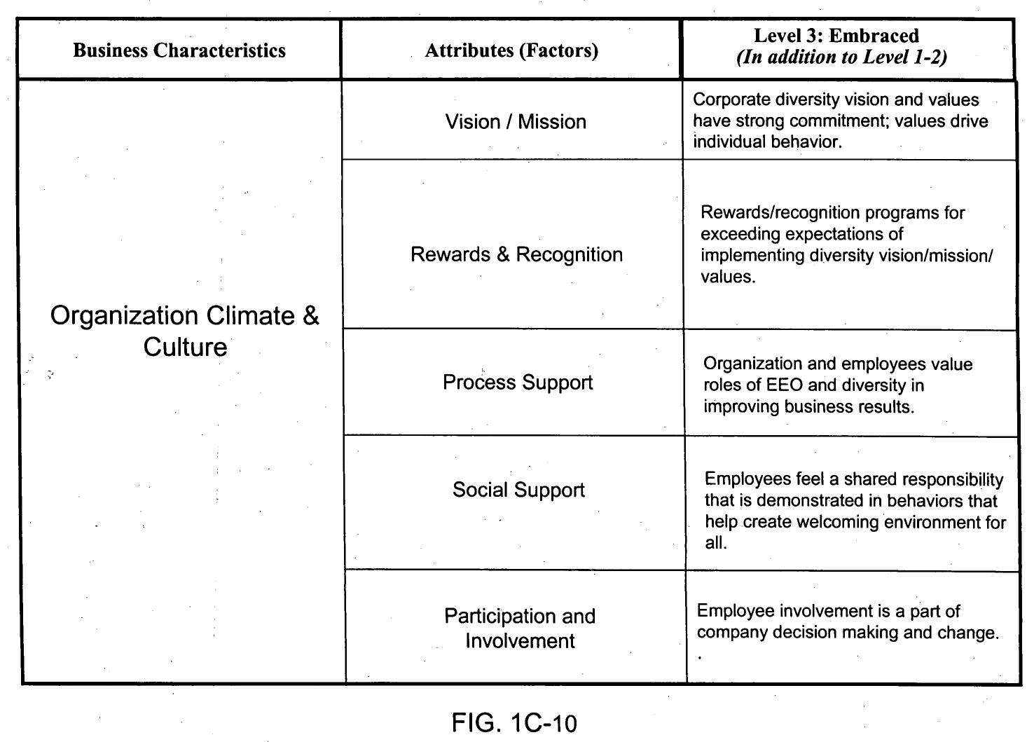

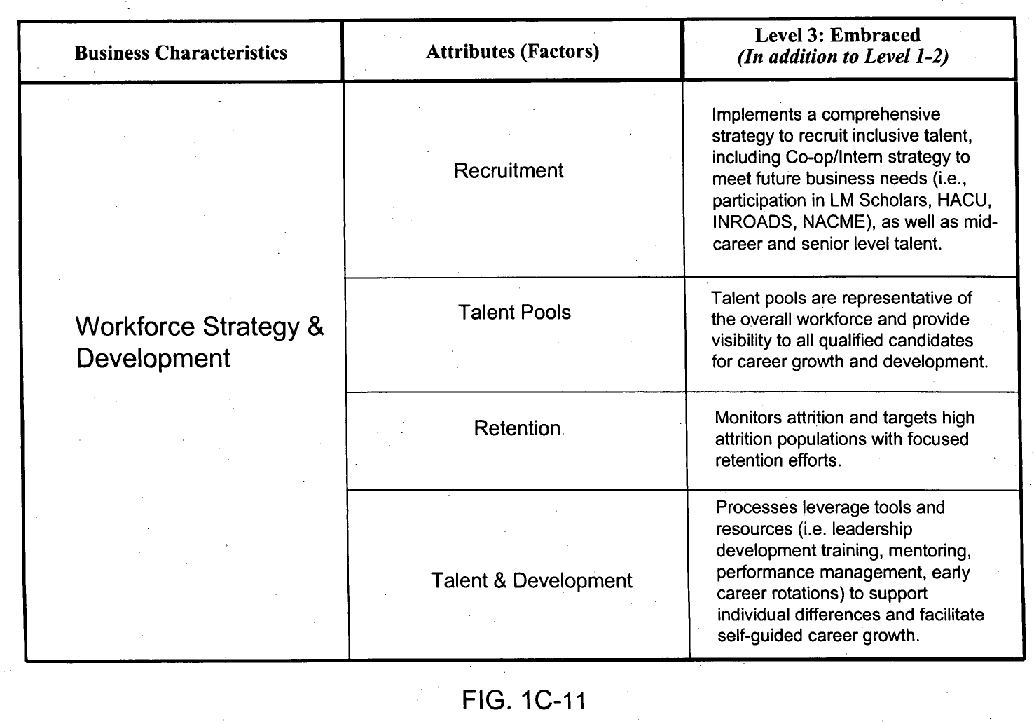

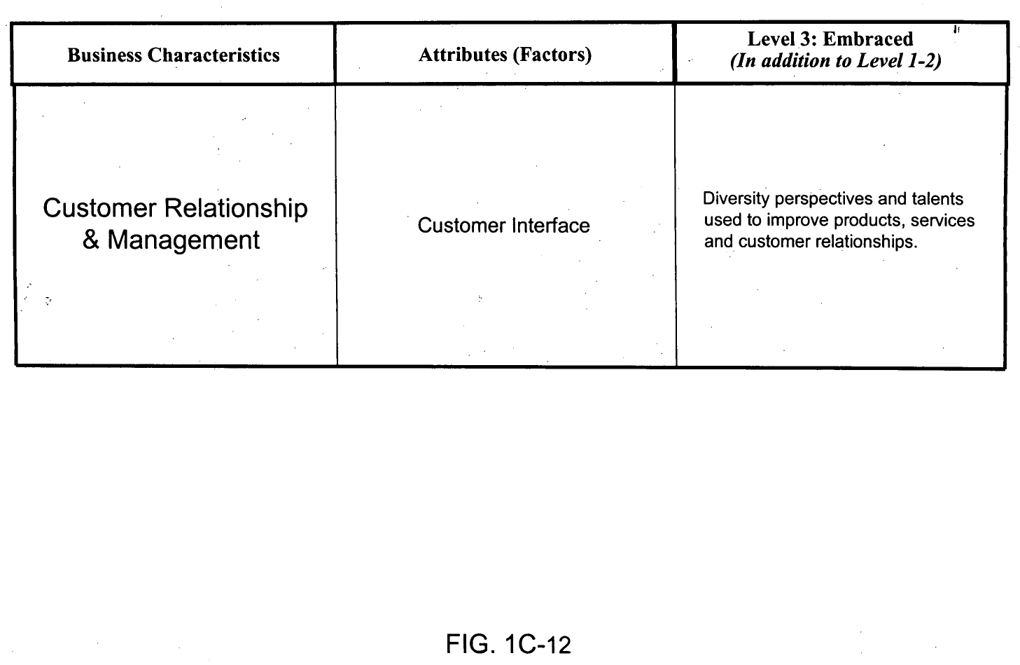

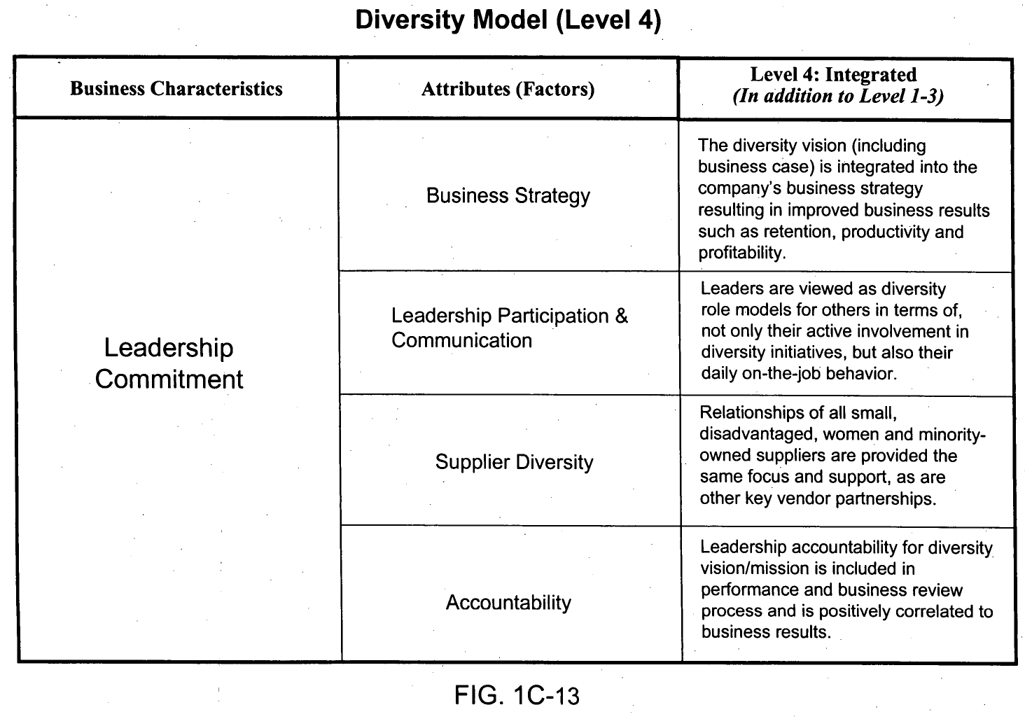

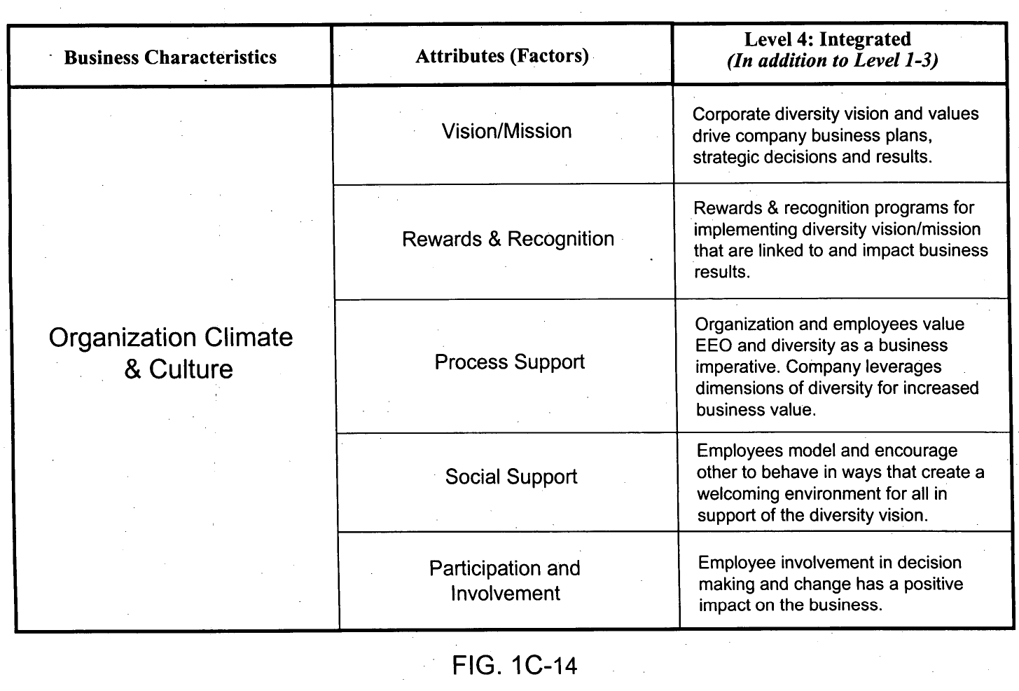

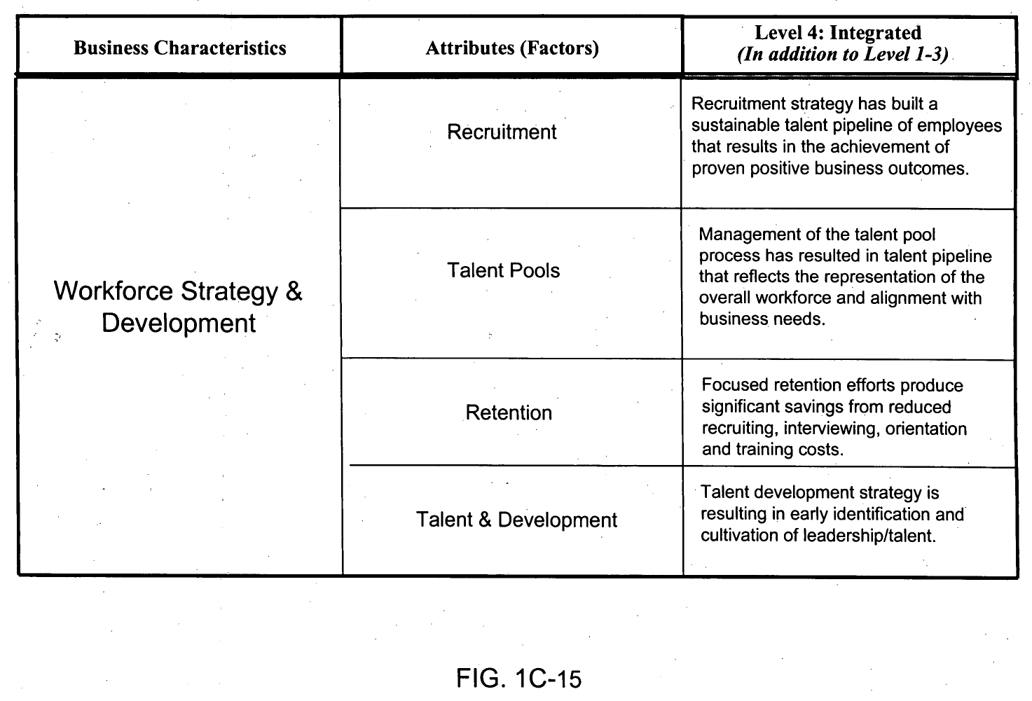

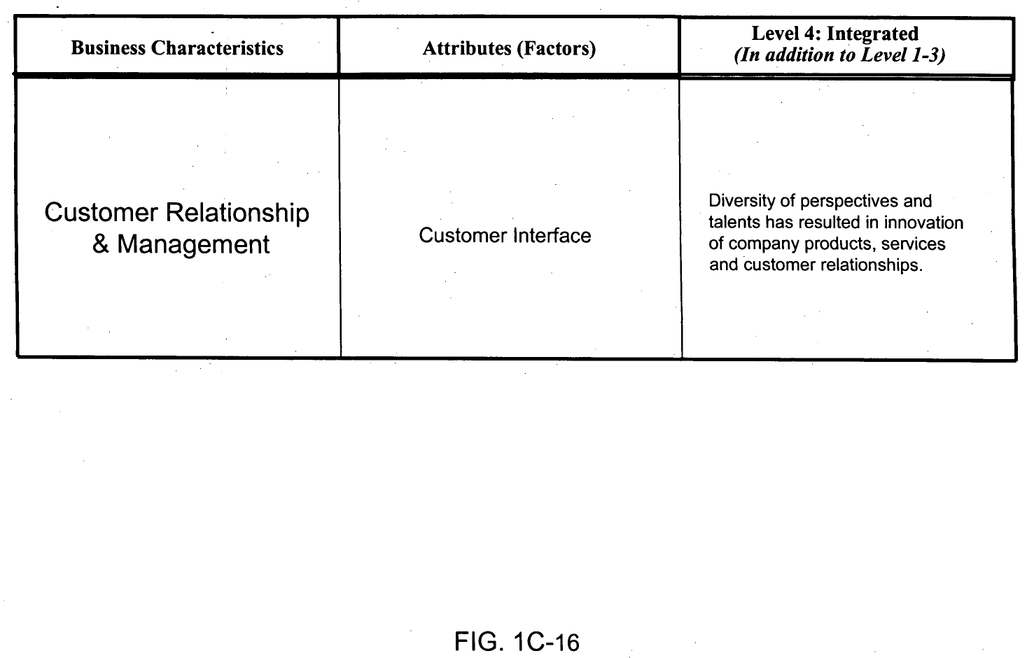

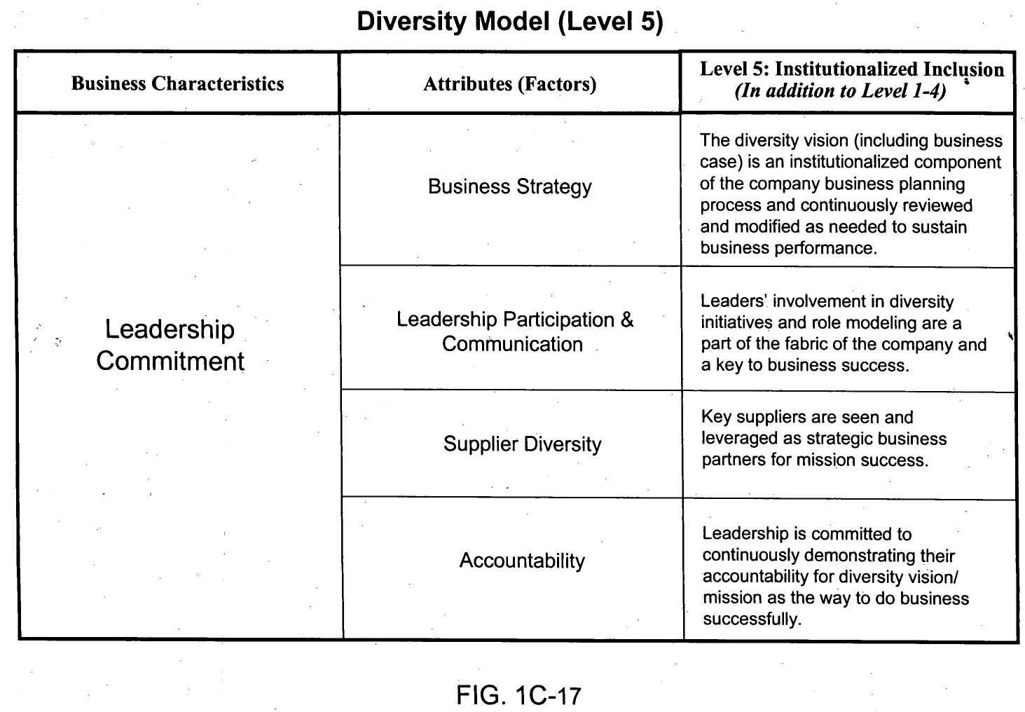

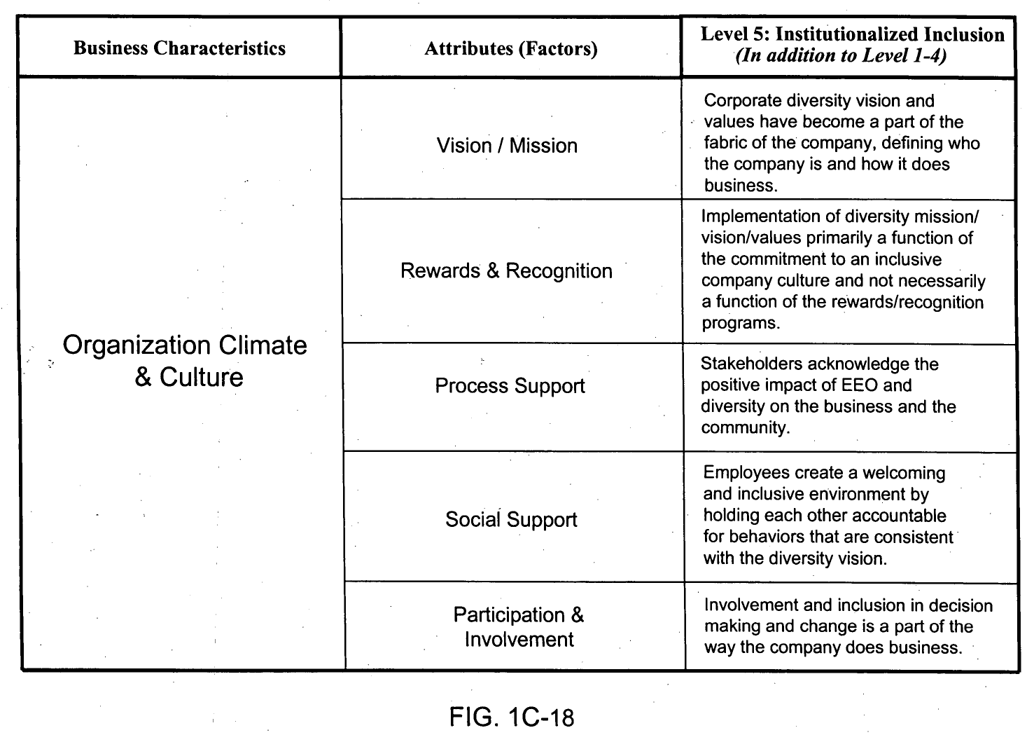

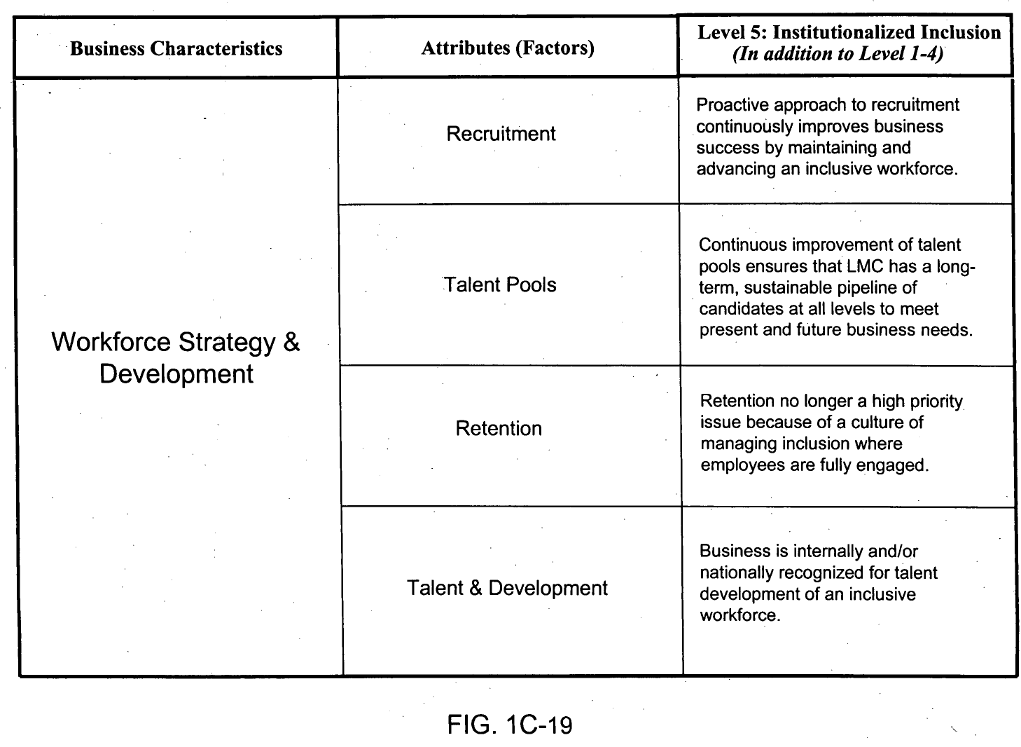

Recognizing that organizations can exhibit multiple internal levels of diversity and that the objective is to move toward greater diversity within the organization, a multi-purpose assessment strategy can be used to initially develop global and/or sub-group diversity characteristics of an organization. The model described above, as shown in FIGS. 1A-1C, illustrates the type of data which might provide insight into current level(s) of diversity within an organization. Various processes for collecting and compiling data are described below.

A variety of data can be collected and used for assessing the extent of diversity in a business. Collected types of data, without limitation, can include employee opinions, organizational processes and practices (which could be entity-wide or associated with entity sub-groups) intended to implement and support diversity, and available objective data which might provide insight into the effectiveness of such processes and practices.

Employee opinions can be obtained through the use of confidential surveys which seek responses to questions designed to determine what employees think about the existing organizational (corporate, governmental, or non-profit) work environment and diversity characteristics of the organization. The surveys can, without limitation, be implemented using discrete paper documents designed to be subsequently scanned, or, can be implemented on-line for employees to directly provide information in a machine readable fornat.

Questions as to organizational processes and practices can be posed to, and answers obtained from, appropriate organizational representatives via scanable documents or on-line. If desired, a peer review process can be incorporated to provide a third party review of such results/answers for purposes of data integrity and verification.

Finally, objective data can be solicited by posing questions to and/or extracting data from organizational record keepers as to demographics, employee retention and organizational performance relative to statutory and regulatory requirements such as equal opportunity or affirmative action.

The above described processes can also be used to collect information as to various diversity related business characteristics. These, without limitation, can include leadership commitment, organizational culture and climate, work force strategy and development, as well as customer relationship and management.

The collected data or information can be processed to obtain various diversity-indicating results, including a global as well as one or more sub-group-related diversity indicating factors or indicia. Such results can be presented in a variety of formats to management. Further, the collected data can be analyzed to locate gaps or areas where process, procedures or the like can be altered to move the organization in the direction of improved or increased level(s) of diversity. Such analysis would preferably be carried out using one or more commercially available data analysis tools.

The results of such analysis can be used to develop one or more plans to promote enhanced organizational diversity. Those plans can be implemented and subsequently, additional data collected and analyzed to assess their impact on the objective of enhancing organizational diversity (i.e., assess whether improvement in diversity is achieved).

FIG. 1A is a diagram of a multi-level, multi-dimensional (multiple business characteristics) diversity model which is applicable, without limitation, to a for-profit business, a non-profit organization, or a governmental entity. Increasing levels of diversity, L₁, L₂ . . . Lₙ, are illustrated on a horizontal axis vs. selected key business characteristics indicated on a vertical axis. Information shown as LCᵢ, OCCᵢ, WSDᵢ, and CRᵢ, for the respective business characteristics represent aspects of the business organization corresponding to Level Lᵢ. Information representative of a level of diversity for a business characteristic, or for an attribute of a business characteristic, is regarded as a definition or indicator of that level for that business characteristic/attribute. Definitions representing degrees of each characteristic correspond to respective levels of diversity. For example, definitions (LC₁ . . . LCₙ) corresponding to degrees of Leadership Commitment can be viewed as corresponding to levels (L₁ . . . Lₙ) of diversity.

It will be understood that diversity definitions at any one level may vary between organizations. Such variations are not a limitation of the invention. However, in accordance with the invention, level L₂ diversity, however defined, is viewed or regarded as being greater than level L₁ diversity either globally or for a portion of the organization. Similarly, level L₃ diversity, globally or as associated with one of the indicated business characteristics, is greater than level L₂ diversity.

Charts, FIGS. 1B and 1C, provide additional information describing key business characteristics with their respective attributes. Those of skill will also understand that the selected business characteristics may vary between organizations. Such variances are not limitations of the invention.

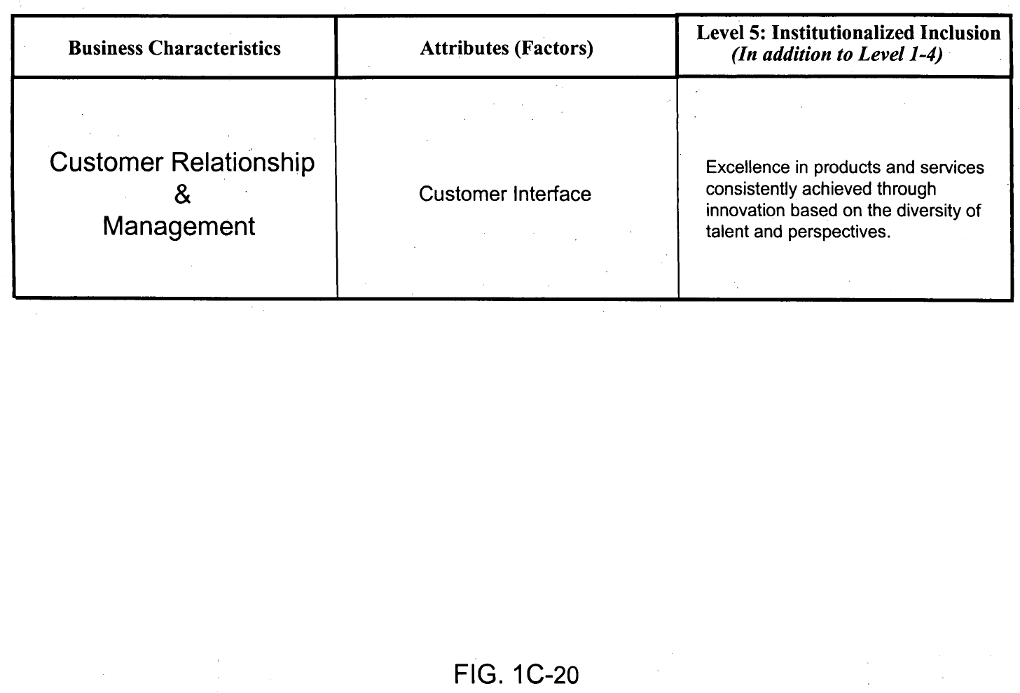

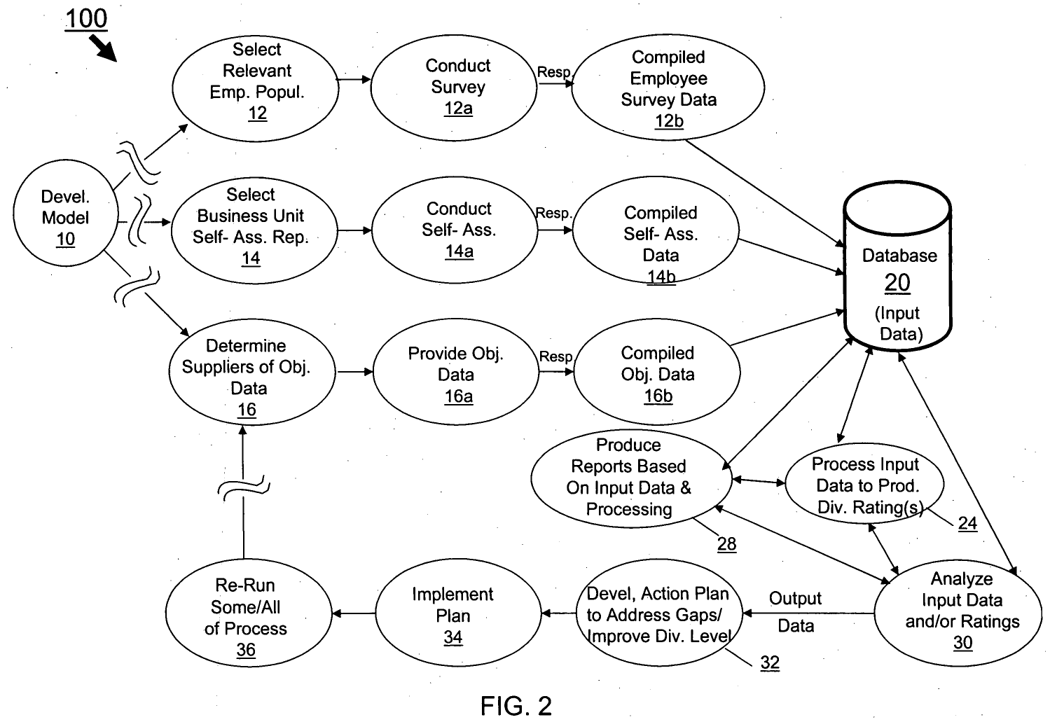

FIG. 2 illustrates a diversity assessment and enhancement (improvement) process 100 based on a multi-level diversity model, such as the Model 10 of FIG. 1A. In process 100, a model such as the Model 10 is developed for use by the organization. Relevant groups of employees 12, organizational representatives 14, and suppliers (sources) of objective data 16 are then identified. Each group is requested to provide information in answer to questions posed by predefined surveys or questionnaires 12a, 14a, 16a. The information being sought reports aspects of the business organization relating to selected key business characteristics, globally or associated with sub-parts of the organization, as indicated by the Model 10 of FIG. 1A.

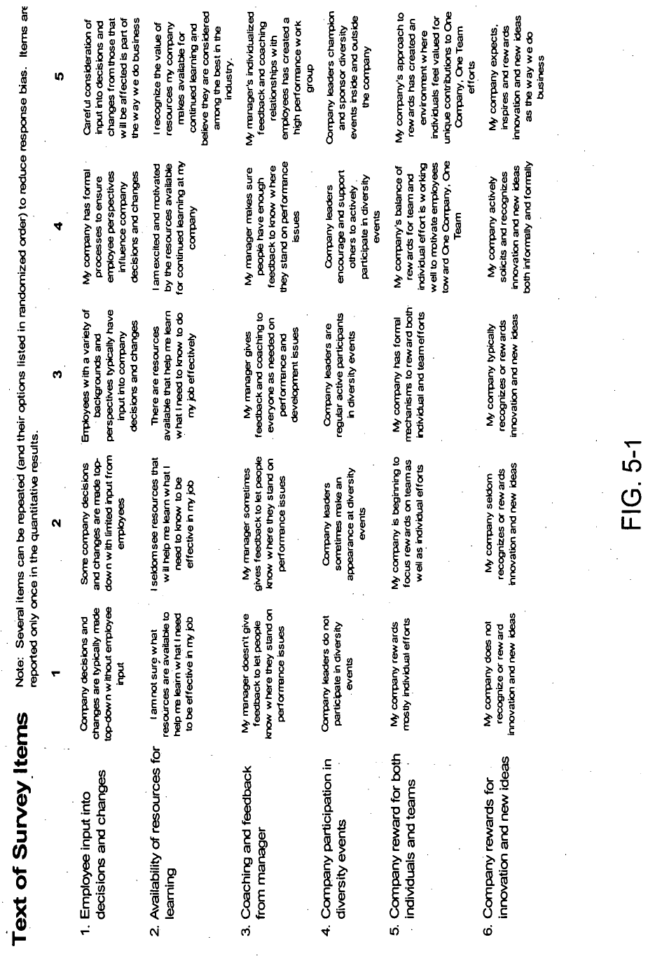

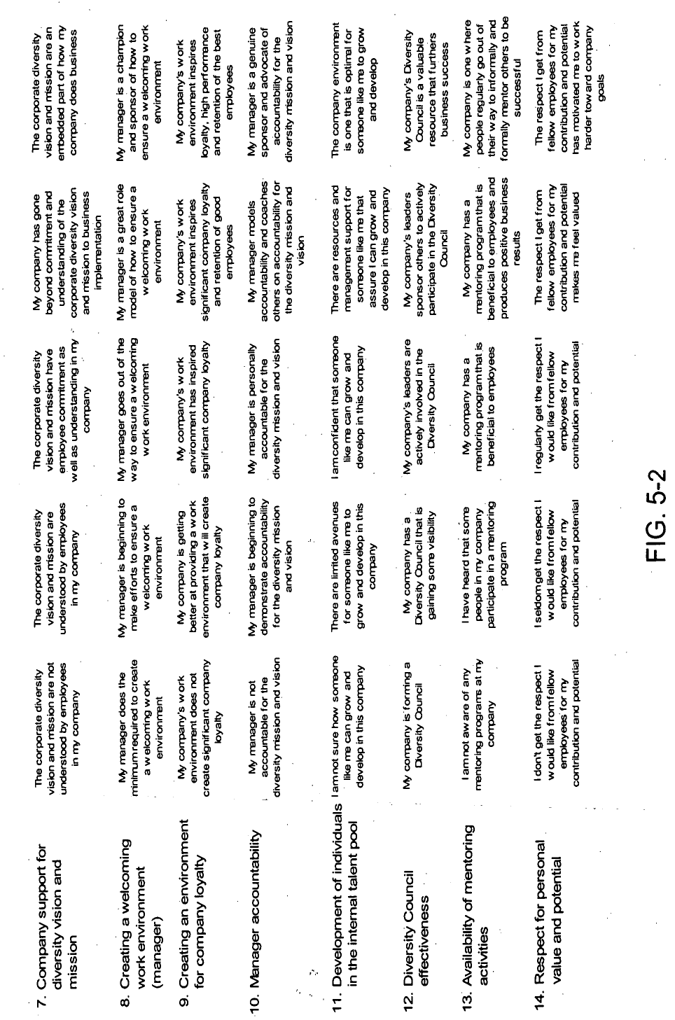

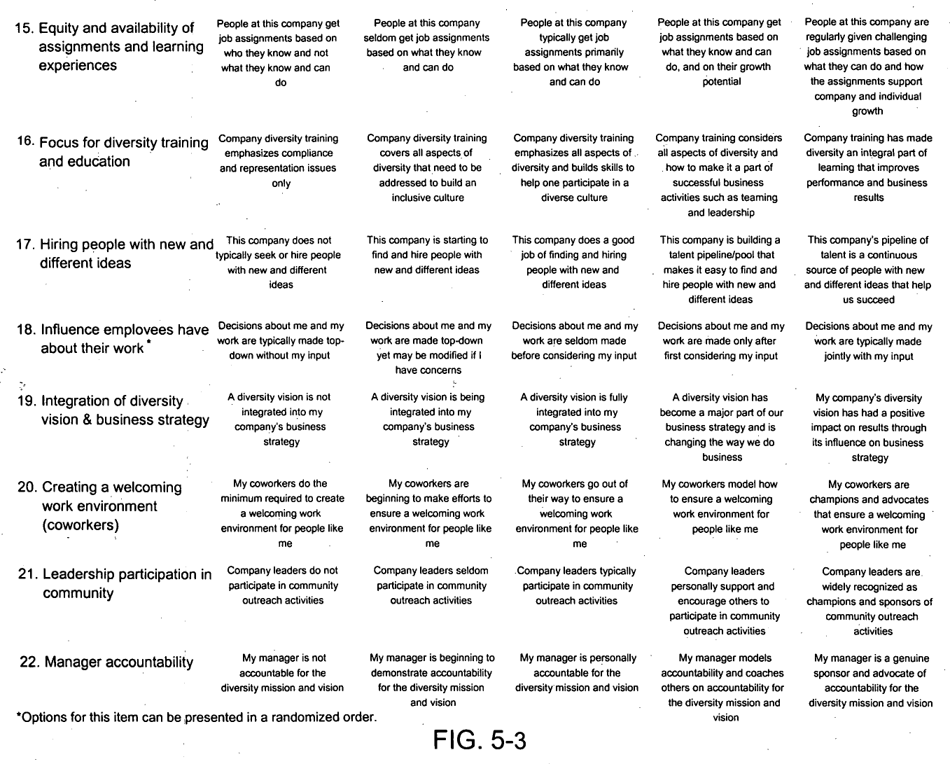

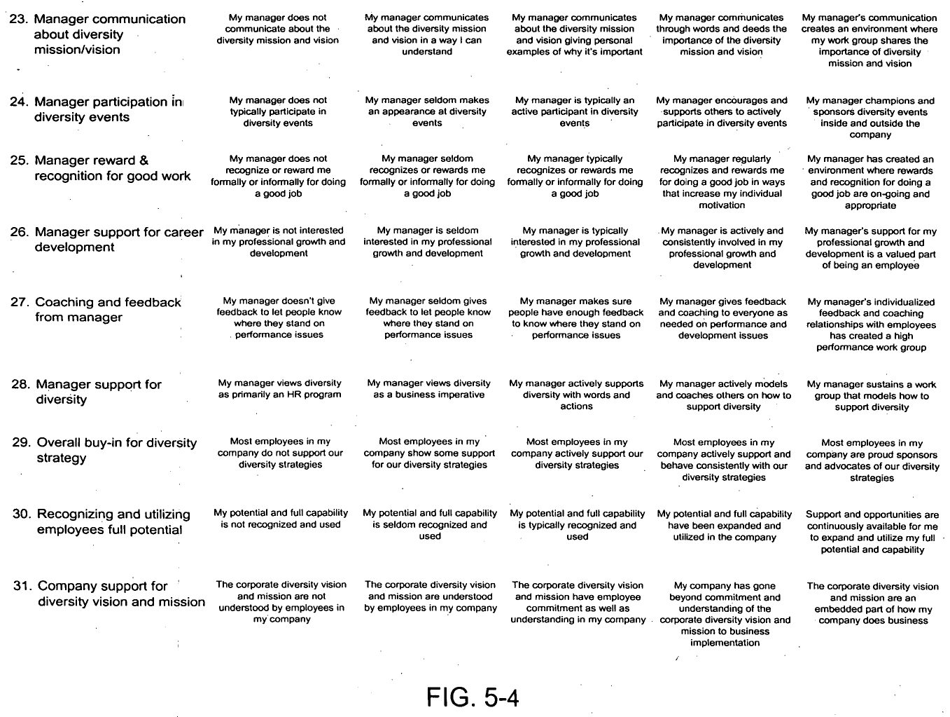

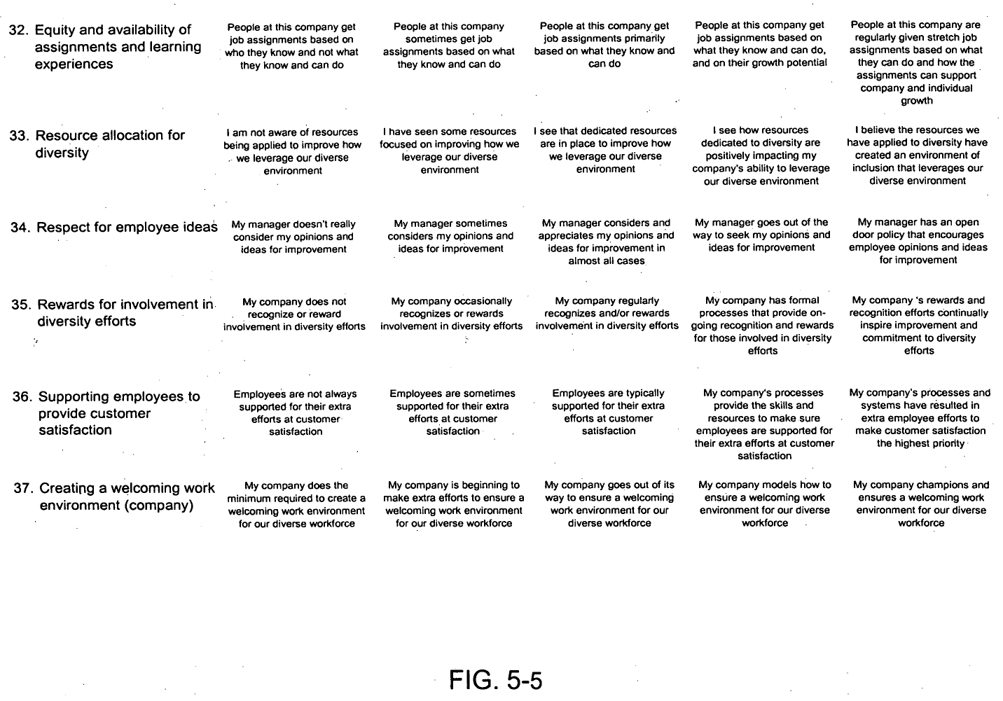

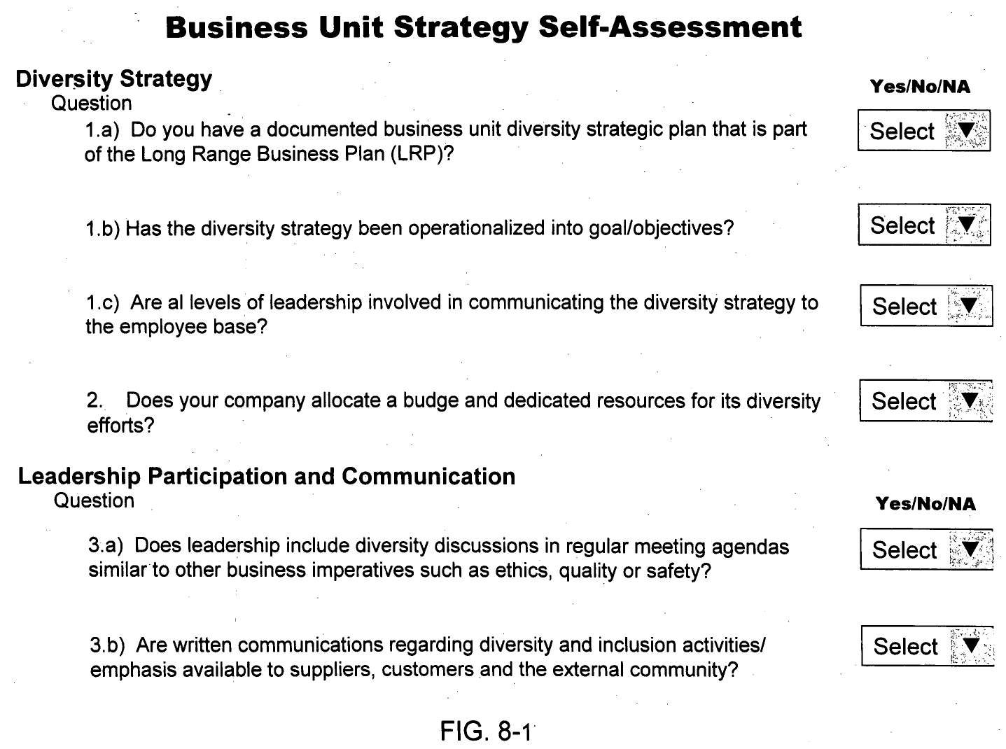

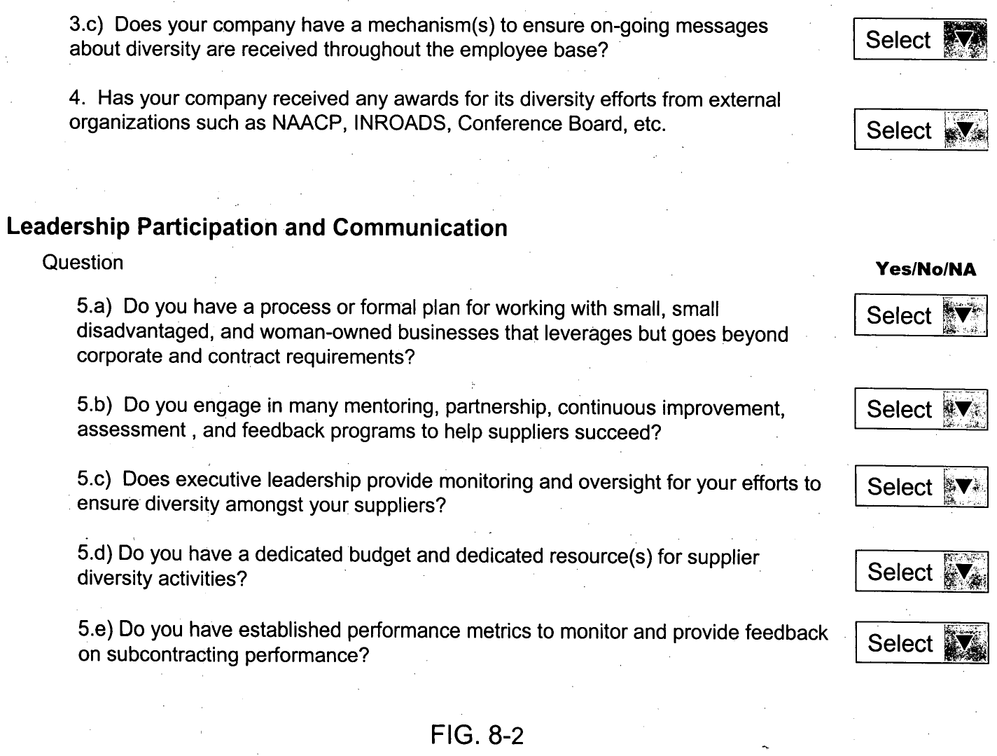

The resulting data or information 12b, 14b, 16b is compiled and stored in a database 20. It will be understood by those of skill in the art that the surveys or questionnaires would be prepared, as discussed above, in accordance. with the Model 10. For example, questions 1c and 5a (FIG. 8) are prepared in accordance with, and relates to the Leadership Commitment business characteristics of the model (FIG. 1C-₁), particularly to Leadership Participation and Communication, and Supplier Diversity, respectively. Also, a question inquiring about Manager Support of the diversity process (refer to Survey Item 28 of FIG. 5) would be in accordance with level 1 of the model relating to process support associated with the Organization Climate and Culture business characteristic (FIG. 1C-₂) . Questions would be prepared specifically for compiling information, in various forms, that would be relevant to the then current level of diversity of the organization. It will also be understood that neither the nature nor the characteristics of the database 20 are limitations of the invention.

The collected data is then input to a processor and processed, as shown in step 24, using a variety of subsequently described techniques or procedures to arrive at one or more diversity ratings for the organization. The diversity ratings are indicative of a current level of diversity for the organization. Following the processing of data, shown in step 24, one or more reports illustrative of current diversity status of the organization can be produced, as shown in step 28.

The input data from database 20, the diversity ratings produced in step 24 and reports produced in step 28 can then be analyzed, as shown in step 30 to identify gaps between current and desired diversity levels for the respective business characteristics, and to determine or otherwise establish those areas, processes or steps within the organization or sub-part thereof which can be varied to facilitate the movement of the organization from its current diversity level, Lᵢ, to the next higher level of diversity Lⱼ. Such analysis can preferably be carried out using one or more commercially available data mining or analysis tools.

It will be understood that neither the specific tool or tools used nor their processing characteristics are limitations of the invention. Representative tools include Microsoft SQL Server, Active Server Pages (ASP), Stored database procedures or Microsoft Excel.

Following the analysis of the processing results, an action plan may be developed and implemented, as depicted in steps 32 and 34, to improve the level of diversity of the organization. Thereafter, the process 100 can be carried out again globally or relative to a portion of the organization to assess changes in diversity levels and the extent of improvement.

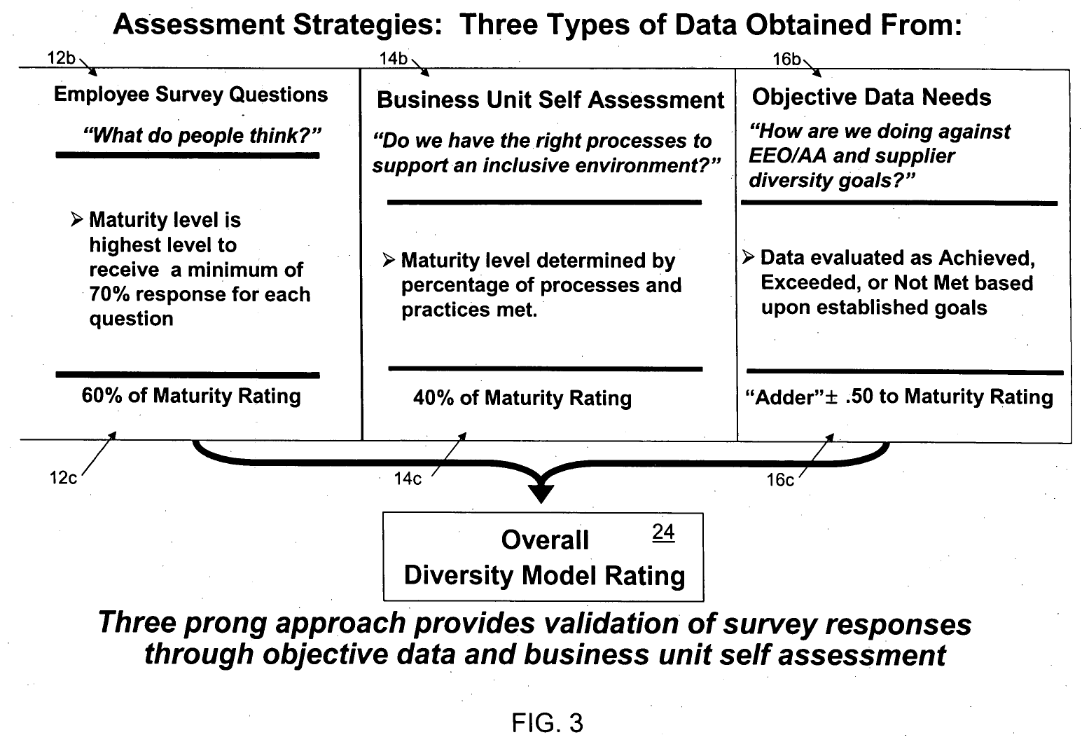

FIG. 3 is a chart of additional exemplary information as to the respective data types 12b, 14b, 16b depicted in FIG. 2. The processing 24 (FIG. 2) of assessment data (FIG. 3) is directed to producing a global or over-all organizational diversity rating.

As illustrated in FIG. 3, each of the data types 12b, 14b, 16b is assigned a weighting factor 12c, such as 60%, for employee feedback information 12b, weighting factor 14c, such as 40% for business unit self-assessment data 14b, and weighting factor 16c of plus or minus 0.5 for the objective data 16b. The weighted data can be used in producing an overall diversity rating, step 24. It will be understood that other weightings come within the spirit and scope of the invention.

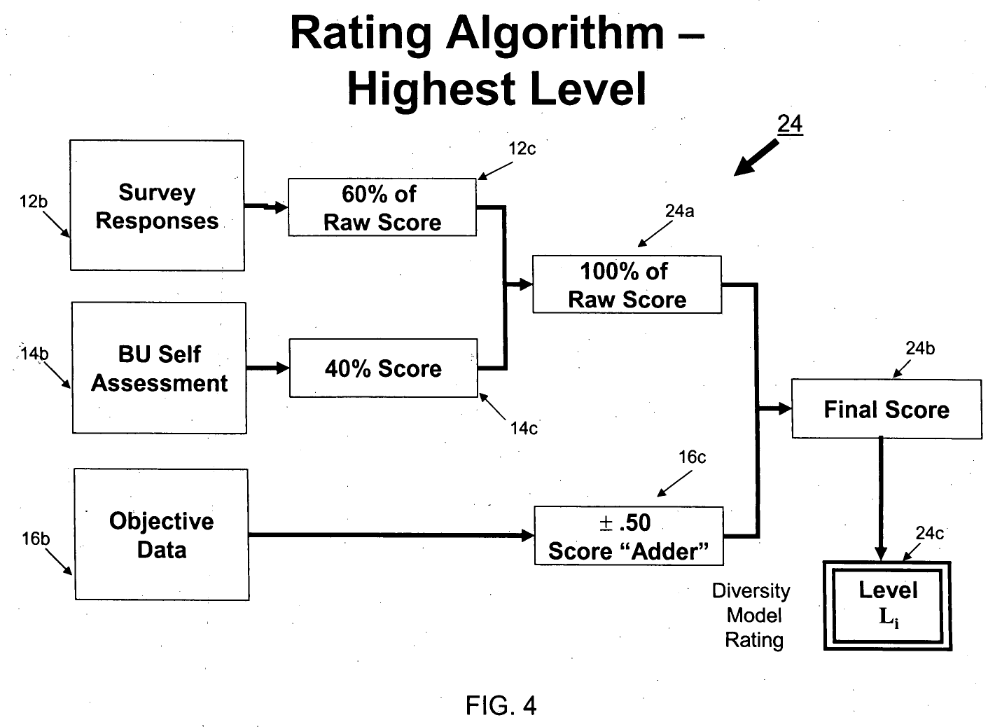

FIG. 4 provides additional exemplary details as to processing step 24 (FIG. 2). Survey responses (12b) can be assigned a weighting (12c) of 60% of raw score (i.e., 60% of the survey response values). Business unit self-assessment information (14b) can be assigned a weighting (14c) of 40% of raw score. The weighted raw scores are added together to form a raw score (24a) corresponding to 100% of the inputs 12b and 14b. The total raw score 24a can be adjusted with objective data (16b), as shown in step 16c, to form a final score (24b) indicative of a diversity level Lᵢ (24c). Variations in the above described processing come within the spirit and scope of the invention.

FIG. 5 illustrates an exemplary employee survey as may be provided to employees (step 12a of FIG. 2). It will be understood that the survey of FIG. 5 discloses the best mode of practicing the invention but is not a limitation thereof. Variations on the survey of FIG. 5 comes within the spirit and scope of the invention as would be understood by those of skill in the art. The survey results, which might include responses from many employees, can be stored in database 20 for subsequent processing.

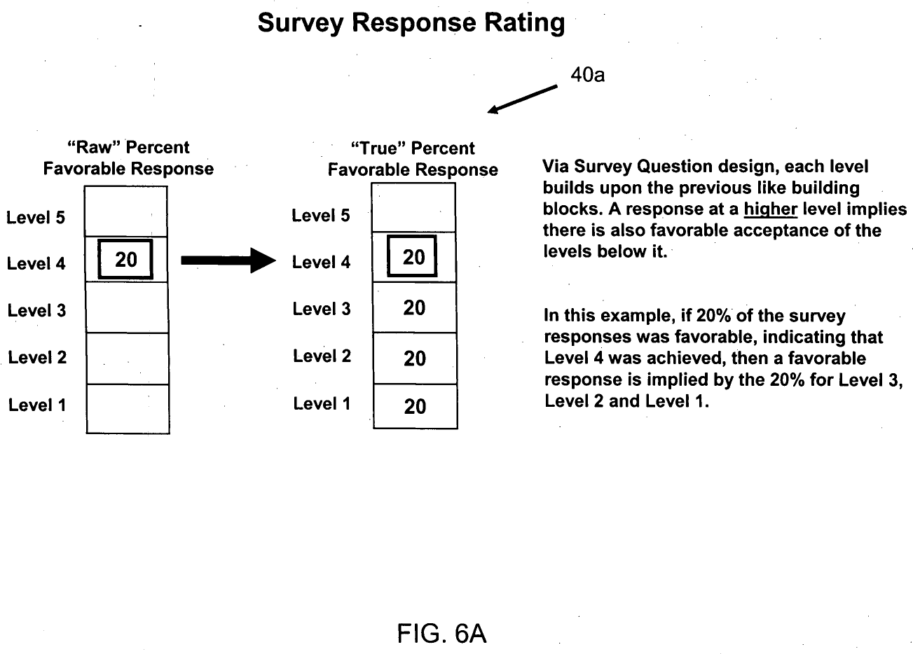

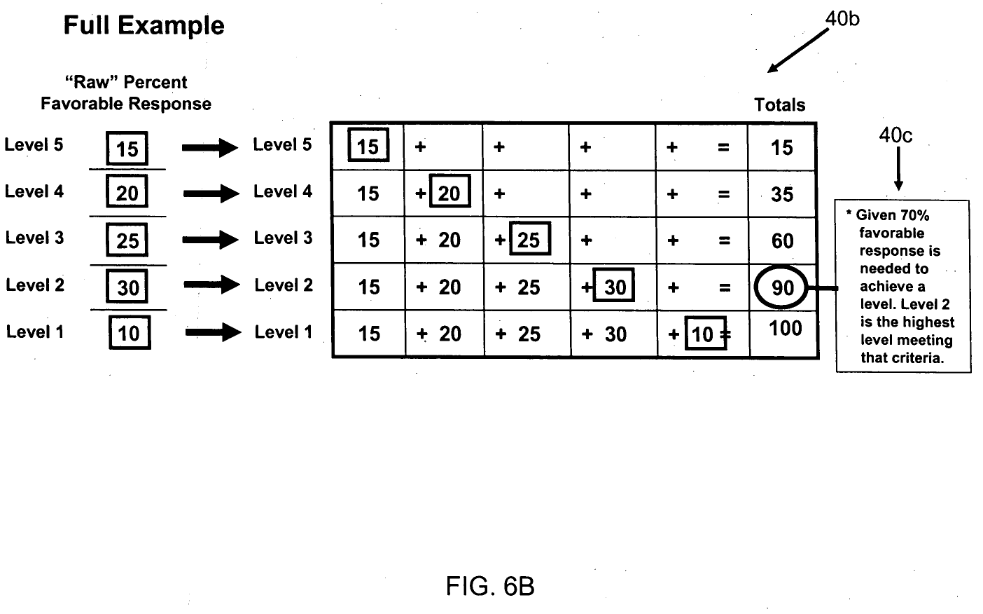

In accordance with step 24 of FIG. 2, FIG. 6A illustrates aspects of exemplary processing of survey results for one question from the survey of FIG. 5. Exemplary processing 40a illustrates that a favorable response to a question, indicating that level 4 was achieved, implies a favorable response to lower levels 1-3 for that question.

Further in accordance with step 24, as illustrated by processing step 40b of FIG. 6B, raw percent favorable responses for each level below the highest level, Level 5 for example, are combined with implied favorable responses from higher levels to produce a total for each level. Where a 70% exemplary threshold has been established, as indicated in step 40c, the highest level meeting that criteria is Level 2 for an exemplary question.

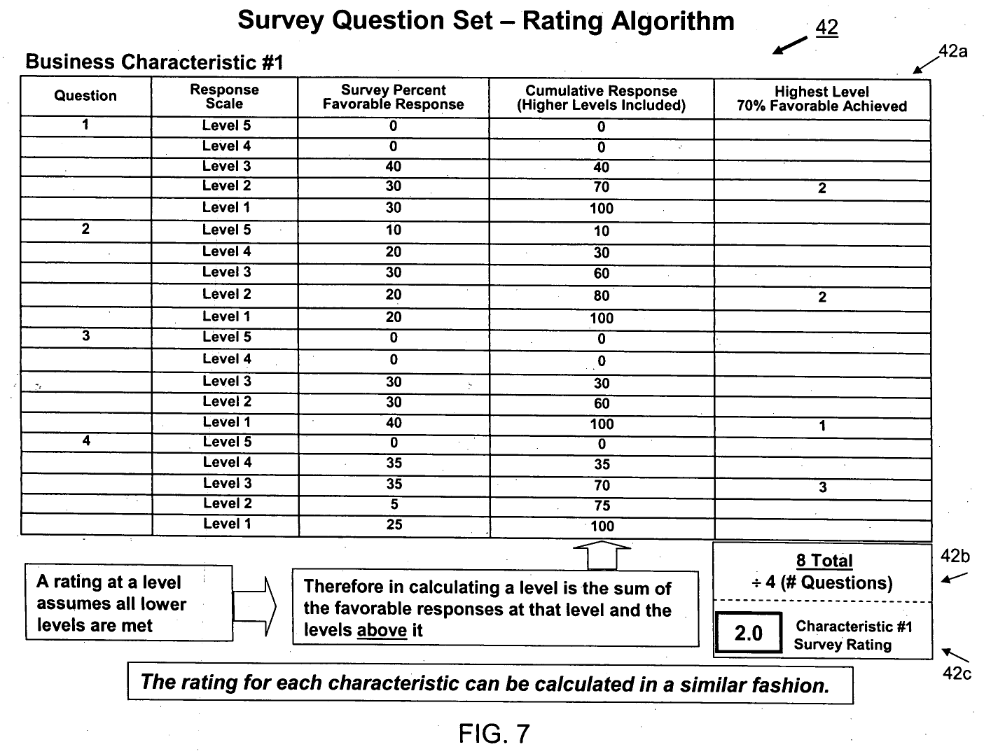

Also in accordance with step 24 of FIG. 2, FIG. 7 illustrates exemplary processing of survey results—the processing of responses to a plurality of survey questions associated with one of the exemplary business characteristics, depicted, for example, in FIG. 1A. With respect to exemplary business characteristic No. 1—leadership commitment—, FIG. 7 illustrates that, for four questions pertaining to that characteristic, the highest level with a 70% favorable achievement (step 42a) corresponded to level 2 for questions one and two. Question 3 only had a level 1 response. Question 4 had a level 3 response. The favorably achieved levels were then totaled and divided by the number of questions, step 42b, to arrive at a survey rating 42c for that characteristic. Ratings for other characteristics could be determined similarly.

FIG. 8 illustrates some exemplary questions, and responses that may be provided by business organizations upon self-assessment. It will be understood that the subject questions might vary in number and subject matter depending on the business characteristics selected. However, they would all be related to the business characteristics of the model (FIGS. 1A-1C).

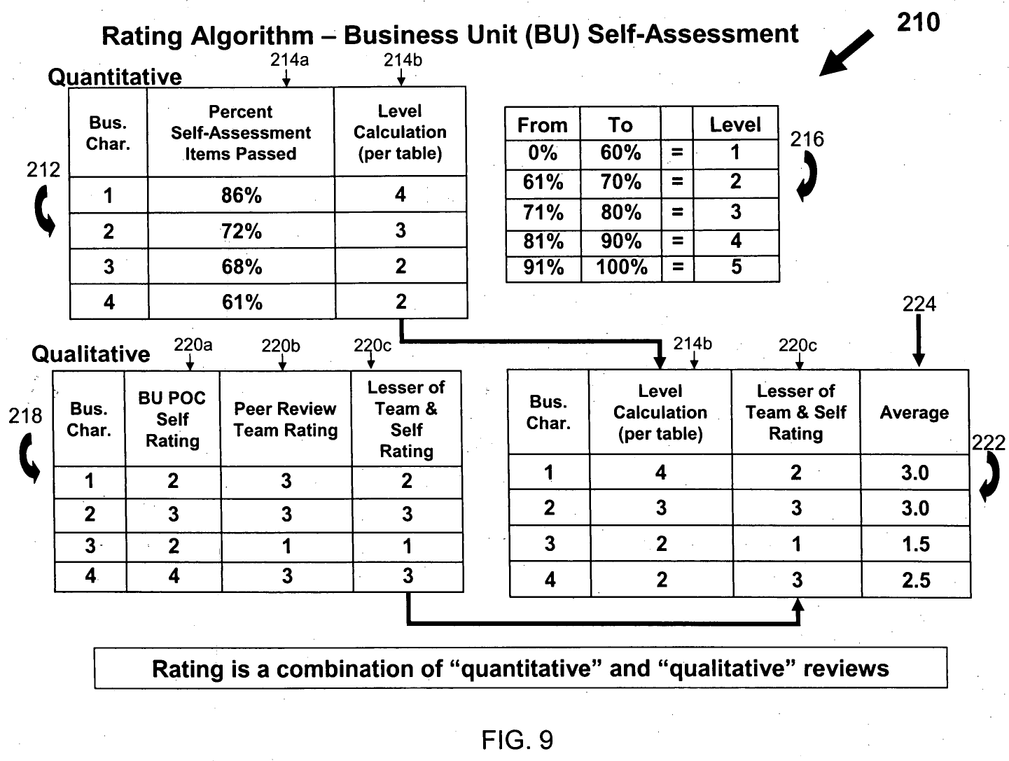

With respect to the processing shown in FIG. 9 of the self-assessment results, it may be desirable to conduct a peer review of the results of the self-assessment survey. Such a review could be conducted, for example by an independent team of individuals from other parts of the business or entity.

FIG. 9 illustrates details of an exemplary business unit self-assessment rating process 210. The business characteristics (see FIG. 1A for example) are evaluated quantitatively (step 212) based on results of the peer review of the self-assessment survey (step 214a). These results can be assigned level values (step 214b) in accordance with table 216.

Business characteristics can be qualitatively evaluated (step 218) by taking into account the business unit self-assessment 220a and the peer review ratings 220b. The lesser of the business unit's self-rating and the peer review rating is selected (step 220c).

In step 222 the level indicia, step 214b, are averaged with the “lesser” rating, step 220c to produce an average diversity value for each of the characteristics, step 224.

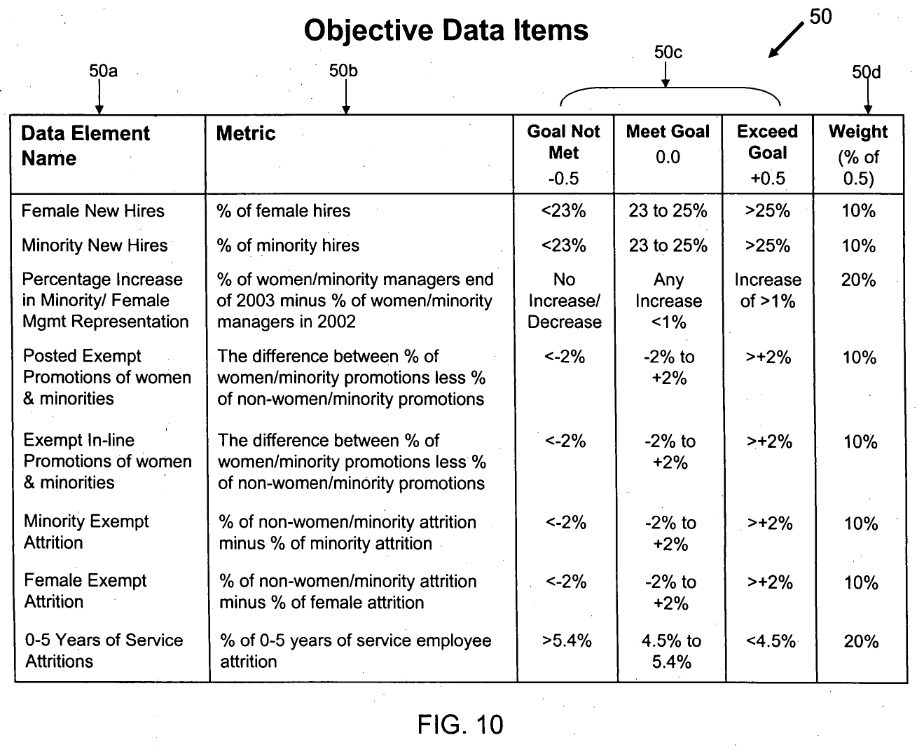

FIG. 10 illustrates exemplary objective data 50. Objective data 50 can include a plurality of data elements 50a and associated metrics 50b. Data 50c represents three sets of assessment data that can be used in combination with relative weights 50d to produce an objective data adder within the plus/minus 0.5 range, as shown in step 16c

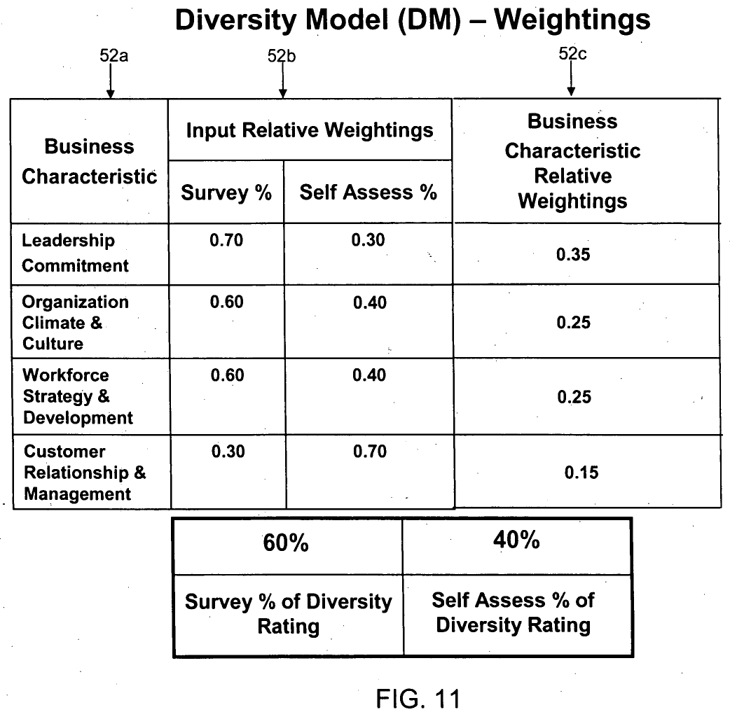

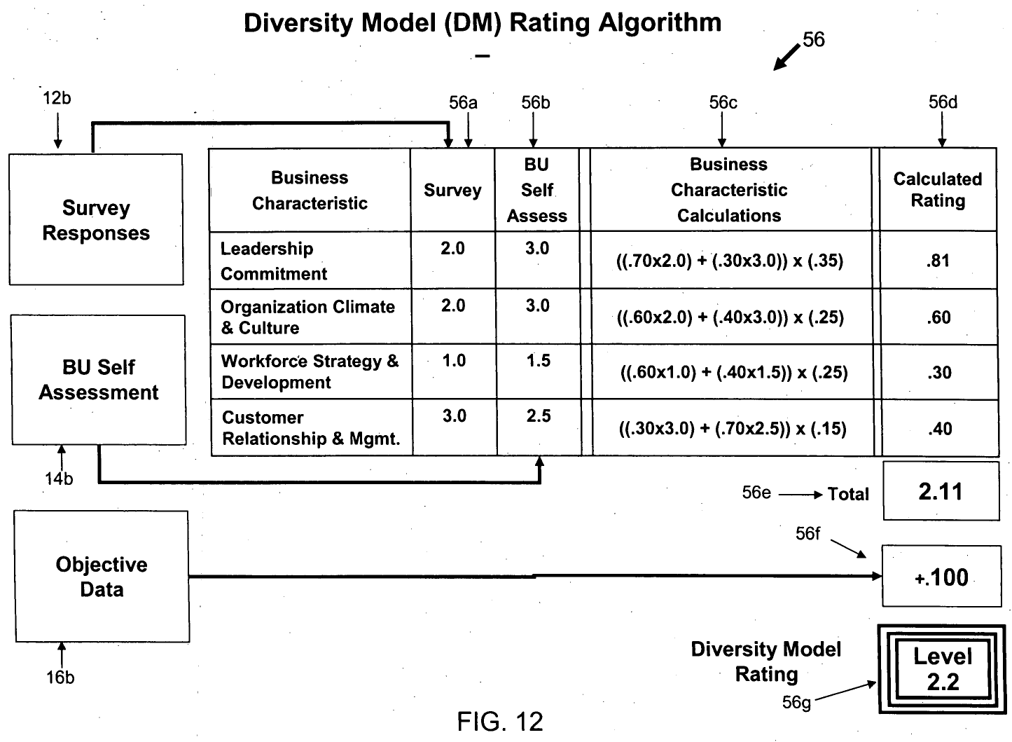

FIG. 11 illustrates, for each of the characteristic types 52a, exemplary input relative weightings 52b and characteristic relative weightings 52c. The weightings of FIG. 11 can be used, as illustrated in FIG. 12, to carry out an overall diversity level calculation 56.

FIG. 12 combines the results of the previously discussed processing (FIGS. 6A, 6B, 7, 9-11) to produce an over-all diversity model rating. In this regard, according to FIG. 12, processed survey data 56a (also shown in FIGS. 6A, 6B, 7), and processed self-assessment data 56b (as disclosed in FIG. 9 for example), for each of the business characteristics, are combined mathematically with respective weightings in step 56c (as shown in FIG. 11), to produce calculated ratings 56d. The ratings 56d are summed to produce a total 56e which is in turn adjusted with the processed objective data 56f (also shown in FIG. 10), to produce an over-all organizational rating 56g indicative of diversity level of the business. It will of course be understood that variations of the above process come within the spirit and scope of the invention.

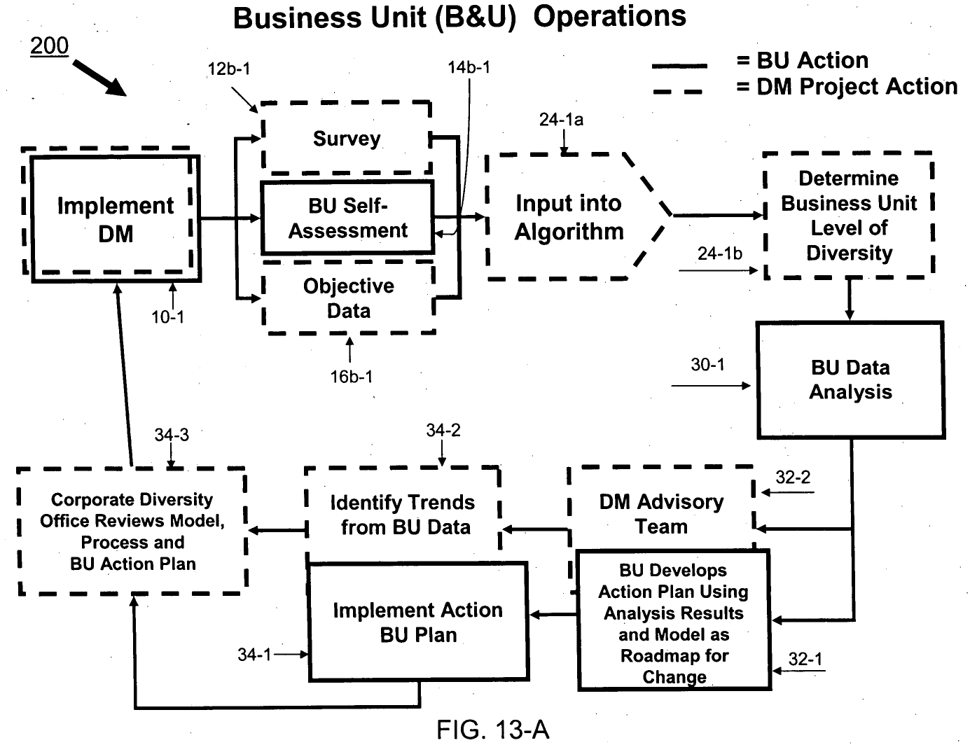

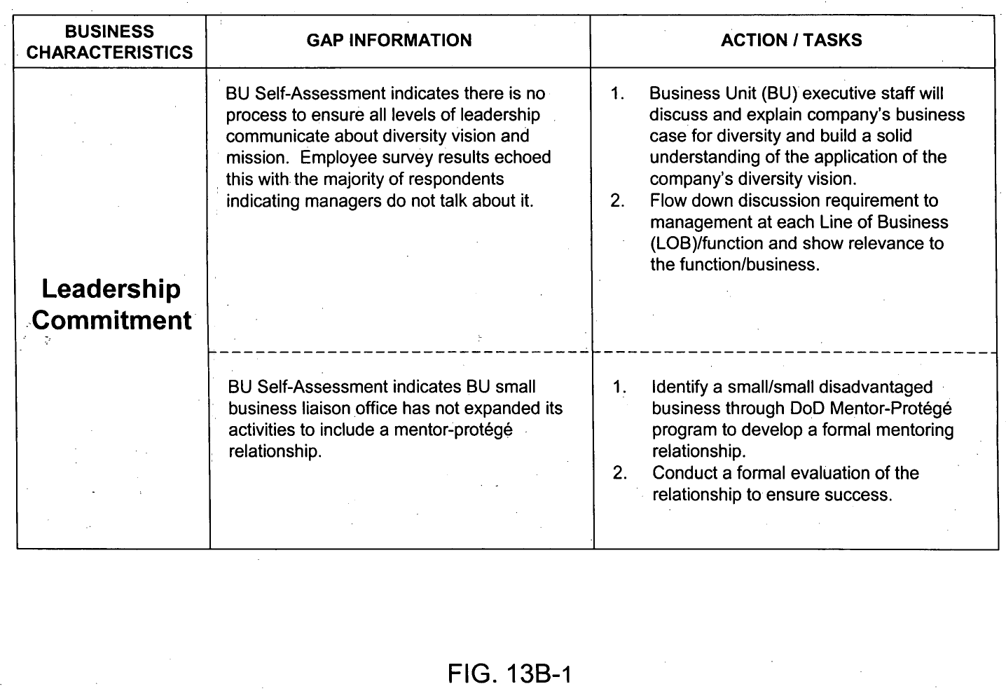

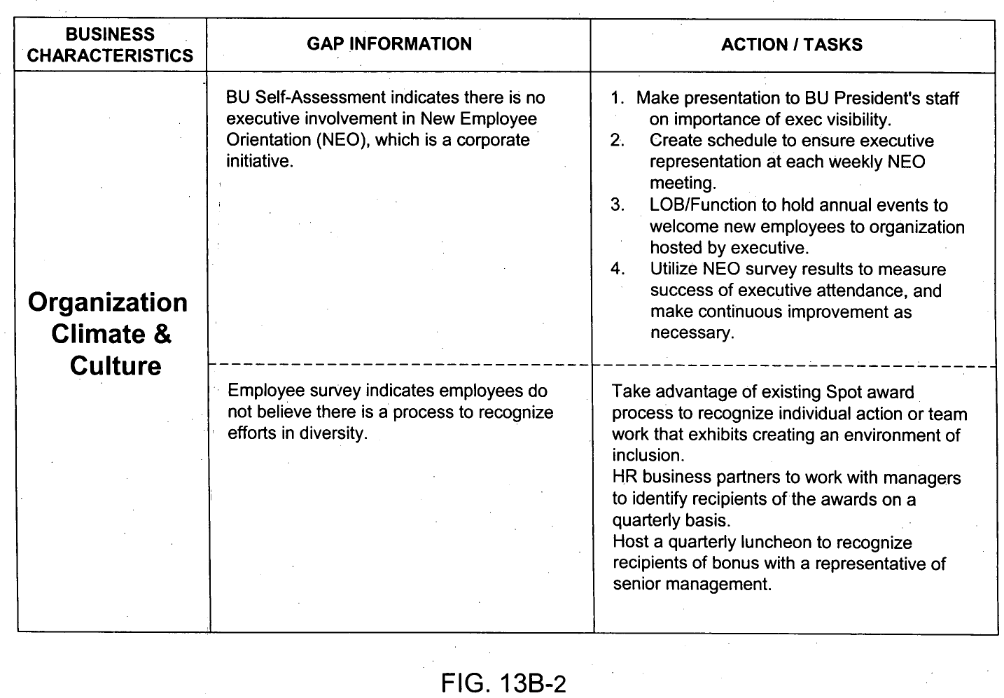

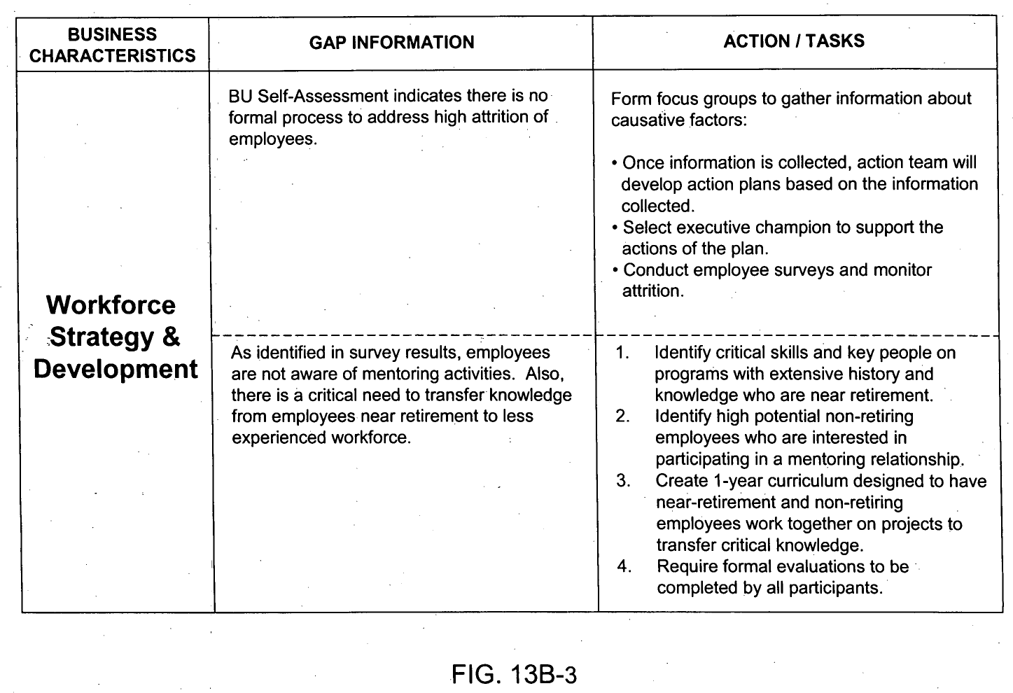

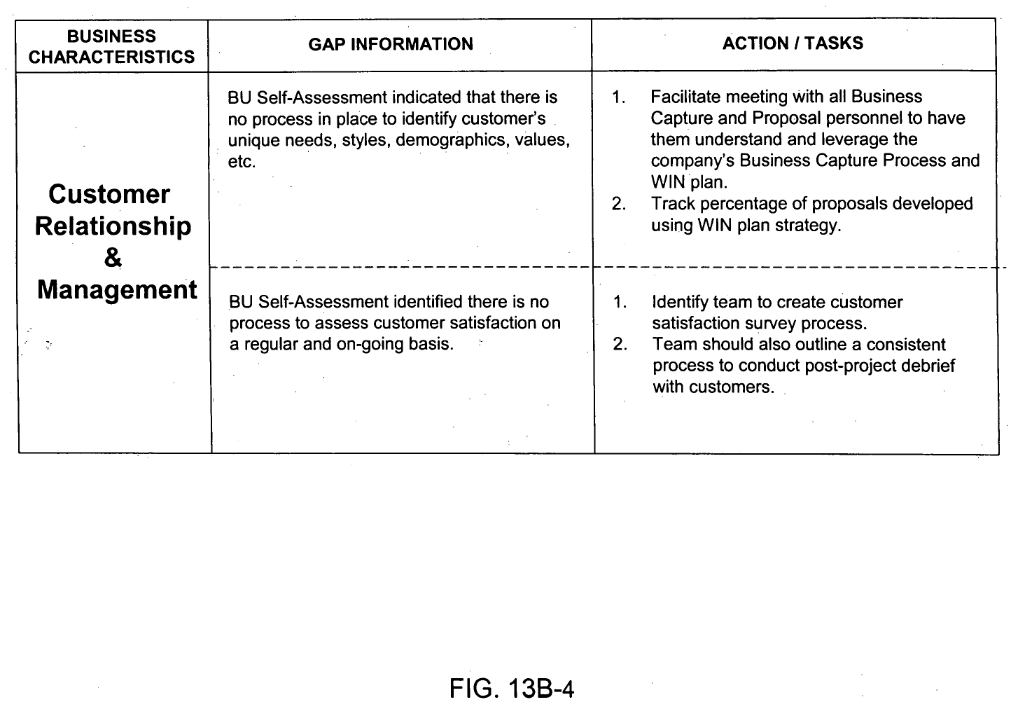

FIG. 13A illustrates a process 200 of assessing and improving a business unit's diversity level. The diversity level can be established on an over-all basis and/or relative to selected business characteristics shown in FIGS. 1A-1C. A diversity model, such as the Model 10 of FIG. 1A is developed (step 10-1 FIG. 13A as discussed above) along with employee questionnaires, self-assessment questions and subject matter for objective data, step 10-1 as discussed above.

The respective data from the survey, 12b-1, self-assessment 14b-1 and objective investigation 16b-1 are then obtained. The various types of data are then processed, step 24-1a, to produce business unit diversity indicia 24-1b. Thereafter, the data can be analyzed, step 30-1. The business unit can develop a plan, step 32-1, as shown in FIGS. 13B-1 to 13B-4, to move to a higher level of diversity, step 32-1, using the results of the analysis and the diversity model. An advisory team can be constituted and made available to assist, step 32-2.

The business unit action plan can be implemented as shown in step 34-1 of FIG. 13A. The advisory team can provide on-going support and suggestions and identify trends in the previously collected data, step 34-2. A corporate diversity support office can provide additional support and feedback, step 34-3. Subsequently, the process can be repeated.

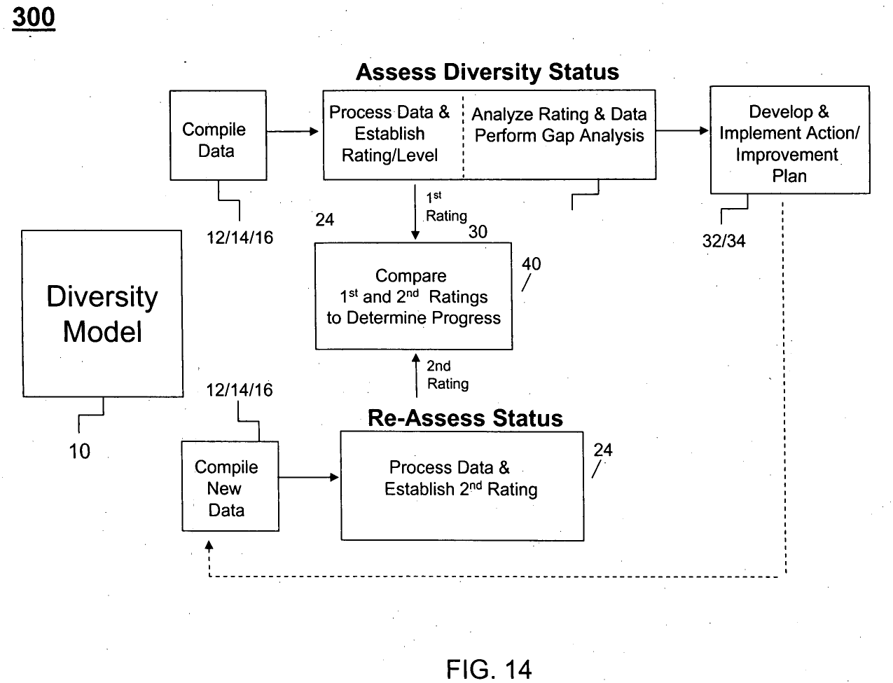

Process 300 shown in FIG. 14 is an alternative representation of processes 100 and 200 (FIGS. 2 and 13A), including the steps of compiling new data after implementing the improvement or action plan (FIG. 13B), re-assessing the diversity status of the organization and producing another rating, and comparing the ratings from the assessment and re-assessment operations to determine progress, if any, made in diversity.

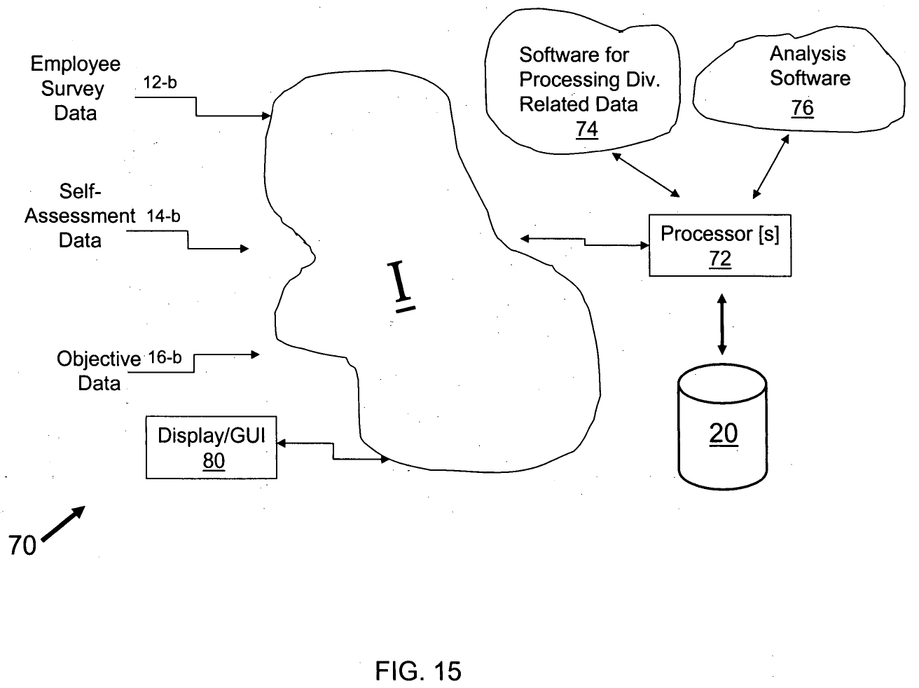

FIG. 15 is a block diagram of a system 70 which embodies the invention. The system 70 includes one or more processors 72 coupled to database 20. Data processing software 74 and analysis software 76 can be executed by processor(s) 72 to carry out the processing and analysis functions in previously discussed methods 100 and 200, based on data in database 20. Data such as employee survey results, 12b, self-assessment information 14b and objective data 16b can be coupled, via a computer network I, as part of an intranet or an internet, to database 20 for subsequent processing by software 74, 76.

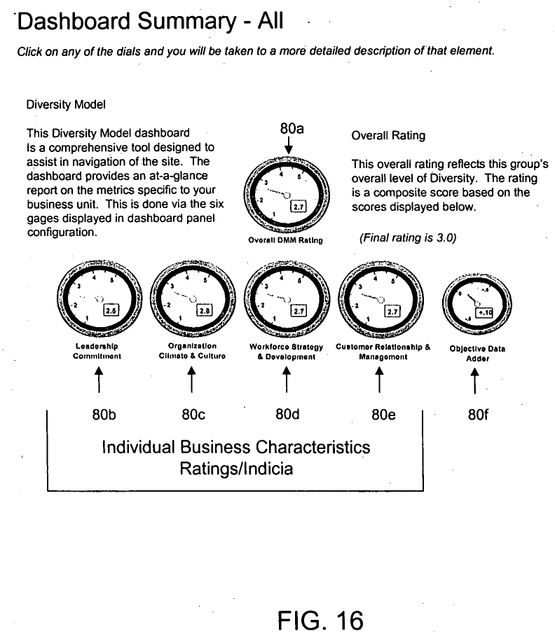

A display with graphical user interface 80 can be coupled, via network I or directly to processor(s) 72, and used to graphically present diversity level information, upon processing the data 20, to management or other personnel. One form of presentation is illustrated by FIG. 16.

The display of FIG. 16 includes an overall-all level indicium 80a (see also 56g of FIG. 12). FIG. 16 also shows indicia 80b, c, d an 80e corresponding to characteristics such as leadership commitment, organization culture and climate, work force strategy and development, and customer relationship and management. If desired, an objective data indicium 80f can also be displayed. It will be understood that other forms of presentation of the respective diversity level indicators come within the spirit and scope of the invention.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed is:

1. A method for assessing and improving diversity of human resources of a business, the method comprising:
establishing a diversity model including information representative of selected business characteristics and progressive levels of diversity;
assessing, in relation to the model, input data representative of diversity of a business for producing a diversity rating for the business as well as output data; and
developing an action plan using the output data, the action plan including information for improving diversity rating and diversity.

2. The method of claim 1 where the selected business characteristics include leadership commitment, organization culture and climate, work force strategy and development, and customer relationship and management.

3. The method of claim 1 where assessing includes:
compiling, in accordance with the model, input data representative of diversity of a business;
producing the diversity rating by relating the compiled input data to the model; and
analyzing at least one of the compiled input data and the diversity rating to produce output data for developing the action plan.

4. The method of claim 3 where compiling includes:
collecting, for use as input data, at least one of employee survey data, business self-assessment data, and diversity-related objective data; and
storing the collected data in a database.

5. The method of claim 3 where compiling further includes the preparation of diversity-related questions in response to which selected employee survey data and business self-assessment data are collected.

6. The method of claim 3 where producing the diversity rating is accomplished by processing the input data, including employing an algorithm that relates the compiled input data to model information.

7. The method of claim 6 where processing includes, for each business characteristic, applying at least a first set of weights to the employee data and at least a second set of weights to business self-assessment data.

8. The method of claim 7 where processing includes the selection and processing of diversity-relevant objective data.

9. The method of claim 6 wherein the diversity rating comprises a numeric value.

10. The method of claim 6 where processing includes producing numeric indicia representative of each of the compiled employee survey data, business self-assessment data, and diversity-related objective data.

11. The method of claim 4 where the database includes data related to commitment of leadership of the business to enhancing diversity within the business.

12. The method of claim 11 where the database includes data relating to organization culture and climate.

13. The method of claim 12 where the database includes data relating to at least one of work force strategy and development.

14. The method of claim 13 where the database includes data relating to customer relationship and management.

15. The method of claim 1 where developing includes implementing the action plan by performing at least one of the actions specified in the plan.

16. A method for assessing diversity of human resources of a business, the method comprising:
establishing a diversity model including information representative of selected business related characteristics and progressive levels of diversity; and
assessing, in relation to the model, input data representative of diversity for a business and producing a diversity rating for the business as well as output data.

17. The method of claim 16 where the selected business-related characteristics include leadership commitment, organization culture and climate, work force strategy and development, and customer relationship and management.

18. The method of claim 16 where assessing includes:
compiling, in accordance with the model, input data representative of diversity of a business;
producing the diversity rating by relating the compiled input data to the model; and
analyzing at least one of the compiled input data and the diversity rating to produce output data for developing the action plan.

19. The method of claim 18 where compiling includes:
collecting, for use as input data, at least one of employee survey data, business self-assessment data and diversity-related objective data; and
storing the collected data in a database.

20. The method of claim 18 where compiling further includes the preparation of selected diversity-related questions in response to which selected employee survey data and business self-assessment data are collected.

21. The method of claim 18 where producing the diversity rating is accomplished by processing the input data, including employing an algorithm that relates the compiled input data to model information.

22. The method of claim 21 where processing includes, for each characteristic, applying at least a first set of weights to the employee data and at least a second set of weights to business self-assessment data.

23. The method of claim 22 where processing includes the selection and processing of diversity-relevant objective data.

24. The method of claim 21 where the diversity rating comprises a numeric value.

25. The method of claim 21 where processing includes producing numeric indicia representative of each of the compiled employee survey data, business self-assessment data, and diversity-relevant objective data.

26. The method of claim 19 where the database includes data related to commitment of the leadership of the business to enhancing diversity within the business.

27. The method of claim 26 where the database includes data relating to organization culture and climate.

28. The method of claim 27 where the database includes data relating to at least some of work force strategy and development.

29. The method of claim 28 where the database includes data relating to customer relationship and management.

30. A method for determining extent of progress in diversity of human resources of a business, the method comprising:
assessing, in relation to a pre-determined diversity model, the diversity status of a business using first input data representative of a level of diversity of the business and producing a first diversity rating for the business;
developing plan showing actions that need to be taken in order for the business to achieve a selected, improved level of diversity;
re-assessing, following implementation of the action plan and in relation to the pre-determined diversity model, the diversity status of the business using second input data representative of current diversity of the business by producing a second diversity rating for the business; and
comparing the first and second diversity ratings to determine extent of progress in diversity.

31. The method of claim 30 where assessing includes:
compiling the first input data;
processing the first input data in relation to the model for producing the first rating;
analyzing the first input data and first rating for producing data, including gap information, from which an action plan may be developed to improve diversity.

32. The method of claim 31 where compiling first input data includes:
collecting at least one of employee survey data, business self-assessment data, and diversity-related objective data; and
storing the collected data in a database.

33. The method of claim 31 where compiling further includes the preparation of a first set of diversity-related questions in response to which selected employee survey data and business self-assessment data are collected.

34. The method of claim 31 where producing the first diversity rating is accomplished by processing the first input data, including employing an algorithm that relates the compiled first input data to Model information.

35. The method of claim 34 where processing includes, for each business characteristic, applying at least a first set of weights to the employees data and at least a second set of weights to business self-assessment data.

36 The method of claim 35 where processing includes the selection and processing of diversity-relevant objctive data.

37. The method of claim 34 wherein the first diversity rating comprises a numeric value.

38. The method of claim 34 where processing includes producing numeric indicia representative of each of the compiled employee survey data, business self-assessment data, and diversity-related objective data.

39. The method of claim 32 where the database includes first input data related to commitment of leadership. of the business to enhancing diversity within the business.

40. The method of claim 39 where the database includes first input data relating to organization culture and climate.

41. The method of claim 40 where the database includes first input data relating to at least one of work force strategy and development.

42. The method of claim 41 where the database includes first input data relating to customer relationship and management.

43. The method of claim 30 where re-assessing includes:
compiling the second input data;
processing the second input data in relation to the model for producing the second rating.

44. The method of claim 43 where compiling second input data includes:
collecting at least one of employee survey data, business self-assessment data, and diversity-related objective data; and
storing the collected data in a database.

45. The method of claim 43 where compiling further includes the preparation of a second set of diversity-related questions in response to which selected employee survey data and business self-assessment data are collected.

46. The method of claim 43 where producing the second diversity rating is accomplished by processing the second input data, including employing an algorithm that relates the compiled second input data to Model information.

47. The method of claim 46 where processing includes, for each business characteristic, applying at least a first set of weights to the employees data and at least a second set of weights to business self-assessment data.

48. The method of claim 47 where processing includes the selection and processing of diversity-relevant object data.

49. The method of claim 46 wherein the second diversity rating comprises a numeric value.

50. The method of claim 46 where processing includes producing numeric indicia representative of each of the compiled employee survey data, business self-assessment data, and diversity-related objective data.

51. The method of claim 44 where the database includes second input data related to commitment of leadership of the business to enhancing diversity within the business.

52. The method of claim 51 where the database includes second input data relating to organization culture and climate.

53. The method of claim 52 where the database includes second input data relating to at least one of work force strategy and development.

54. The method of claim 53 where the database includes second input data relating to customer relationship and management.

55. A model representative of levels of diversity of human resources of a business, the model comprising:
information representing progressive levels of diversity;
information representing selected business characteristics relating to diversity; and
information representing aspects of the business relating to the business characteristics and diversity levels.

56. A model as in claim 55 where said aspects include information representative of business status and employee behaviors and actions.

57. A model as in claim 56 where the selected business characteristics include at least one of leadership commitment, organization culture and climate, work force strategy and development, customer relationship and management.

58. A model as in claim 57 including selected business-related attributes associated with the business characteristics.

59. A model as in claim 58 where the attributes include at least one of business strategy, leadership participation and communication, supplier diversity, accountability, rewards and recognition, process support, social support, participation and involvement, recruitment, talent pools, retention, talent development, and customer interface.

60. A model as in claim 55 where the associating information includes selected criteria associated with each attribute, the criteria being useful for identifying the diversity level of a business.

61. A system for assessing diversity of human resource of a business organization, comprising:
diversity model including diversity-related information;
database of diversity-related data, usable in accordance with the model for determining diversity status of the organization;
processor, including software installed and executable thereon, disposed for processing the data and information and producing at least one numeric rating indicative of diversity of the business organization.

62. A system as in claim 61 wherein the processor is also disposed for analyzing the rating and the data and associated diversity-related indicia to determine gaps between the diversity level represented by the rating and a selected diversity level.

63. A system as in claim 62 wherein the processor, in performing the analyzing, is also disposed for producing data useful for developing an action plan for improving diversity.

64. A system as in claim 63 wherein the processor is also disposed for comparing diversity ratings to determine extent of progress in diversity.

65. A system as in claim 61 wherein the processor includes software for producing a plurality of diversity ratings, one rating for each selected business characteristic.

66. A system as in claim 61 wherein the processor includes software for displaying reports including diversity ratings and related indicia.
